(19) United States
(12) Patent Application Publication
(10) Pub. No.: US 2016/0314522 A1
(43) Pub. Date: Oct. 27, 2016

(54) LEASE PURCHASE SYSTEM AND METHOD

(71) Applicant: Rent-A-Center West, Inc., Plano, TX (US)

(72) Inventors: Barry Lee Kabello, Flower Mound, TX (US); Gregory Adam Shulman, Plano, TX (US); James Thomas Villalon, McKinney, TX (US); Andrew Etter Brown, New York, NY (US); Daniel James Logan, Denver, CO (US); Connor Louis Sage, Cincinnati, OH (US); Michael Brian Jackson, Marietta, GA (US); Kevin John Hogan, Frisco, TX (US); Benjamin Cory Bruckhart, Denver, CO (US)

(21) Appl. No.: 14/696,217

(22) Filed: Apr. 24, 2015

(51) Int. Cl. G06Q 30/06; G06Q 20/18; G06Q 20/34; G06Q 20/02; G06Q 20/38; G06Q 20/10

(52) U.S. Cl. CPC G06Q 30/0645; G06Q 30/0609; G06Q 30/0625; G06Q 30/0635; G06Q 30/0641; G06Q 20/3825; G06Q 20/102; G06Q 20/34; G06Q 20/023; G06Q 20/18

(57) ABSTRACT

Embodiments of the invention provide a system and method for generating a lease-purchase agreement including a non-transitory computer-readable medium with software instructions a processor configured to execute the software instructions to cause the system to couple to a front end client including a customer interface including an approval and order session, to process a customer application by verifying a customer in the approval session, and switching to the order session to enable an approved customer to select a good, review an estimate, select a payment option, and order a good. The customer can review an initial and monthly payment, optionally select a user-definable early purchase option payment amount if applicable, and sign a lease agreement generated by the system. The front end client can be a web coupled device, where the approval and order sessions transmit over the Internet, or a kiosk device that displays the approval and order sessions.

### BACKGROUND

This invention relates generally to financial transactions. More particularly, this invention relates to a system and computer-implemented methods for creating rent-to-own and/or lease-purchase agreements.

“Rent to own” and/or “lease-purchase” transactions are lease agreements for the use of merchandise by a consumer for personal, family, or household purposes, for an initial period of four months or less that are automatically renewable with each payment after the initial period, and that permit the consumer to become the owner of the merchandise. The transaction is generally defined as not being a credit sale or a financing arrangement and does not create a security interest as title is not transferred at agreement creation. The transaction allows consumers to acquire the use of household products without incurring debt or the long-term financial obligations associated with credit sales. Customers who do not choose to obtain ownership can return the merchandise without further obligation.

Lease-purchase methods can provide an option to expand business to markets that rely upon credit sales and consumer finance that may otherwise be limited by a calculated or perceived financial risk. For example, in part due to the credit lending industry's reliance on traditional credit bureaus, many potential customers are precluded from acquiring products through traditional credit financing methods because they do not meet credit approval standards. Moreover, rent-to-own products and services historically have not enabled virtual payments using cash and are generally only available at specialized rent-to-own outlets.

Using some embodiments of the system and methods described herein can minimize the risk of losses and can enable companies to reach a hitherto untapped source of portfolio growth and expansion while managing concerns about the security of their balance sheet.

### SUMMARY OF THE INVENTION

Some embodiments include a system for generating a lease-purchase agreement comprising a non-transitory computer-readable medium in data communication with at least one processor, where the non-transitory computer-readable medium includes software instructions comprising a lease-purchase system and method, and one or more processors configured to execute the software instructions. Execution of the software instructions causes the system to couple to at least one front end client comprising a customer interface comprising an approval session and an order session, where the approval session configured to enable the customer to switch to the order session in the customer interface once approved. Further, execution of the software instructions causes the system to process a customer application by initiating a customer approval engine in the approval session, to receive customer information from a customer, and to couple to at least one verification server. Further, execution of the software instructions causes the system to instruct the at least one verification server to execute at least one verification based at least in part on the customer information, where the at least one verification server transmits to the approval engine at least one notification based on the at least one verification. Further, execution of the software instructions causes the system to determine an approval based at least in part on the at least one notification, and based on the approval, optionally entering an order session and initiating an ordering engine to create a customer order. Further, execution of the software instructions causes the system to display at least one order selection page in the customer interface and configure the customer display to receive order selection instructions from the customer for at least one good. Further, execution of the software instructions causes the system to couple to at least one quote server, instruct the at least one quote server to execute at least one quotation estimate based at least in part on the customer order, where the at least one quote server transmits to the ordering engine at least one quotation estimate. Further, execution of the software instructions causes the system to generate at least one lease agreement related to the at least one good by coupling to at least one agreement server, and receive and display at least one lease agreement in the customer interface and configure the customer display to receive a customer signature or legally binding approval from the customer.

In some further embodiments, the one or more processors are further configured to execute software instructions that cause the system to enter a sales associate mode including generating and displaying at least one customer progress dashboard. In some further embodiments, the one or more processors are further configured to execute software instructions that cause the system to display a customer order, where a viewing user can enter a confirmation of the customer order to initiate the order from the at least one customer progress dashboard.

In some embodiments, the one or more processors are further configured to execute software instructions that cause the system to enable a viewing user to review and execute an invoice and delivery related to the at least one good. In some further embodiments, the one or more processors are further configured to execute software instructions that cause the system to enable the front end client to accept an initial payment for the at least one good. In some embodiments, the initial payment comprises a credit/debit card account from the customer either directly input into the lease-purchase system and method or processed through an online payment solution. In other embodiments, the initial payment comprises an electronic funds transfer or automated clearing house authorization through an online payment solution. In some further embodiments, the initial payment can be taken as any combination of credit and cash. In some embodiments, the online payment solution comprises at least one of ePay, Autopay, PayPal®, Apple Pay™, Google Wallet™, Amazon Payments, and Skrill payments.

In some embodiments, the order session comprises displaying at least one order selection page, where the order selection page is configured to enable the customer to select the at least one good by department or category. In some further embodiments, the order selection page comprises at least one good customization tool.

In some embodiments, the one or more processors are further configured to execute software instructions that cause the system to define a price restriction on the at least one order, the price restriction including a specified minimum and maximum value. In some further embodiments, the one or more processors are further configured to execute software instructions that cause the system to display an estimate review display in the order session. In some embodiments, the estimate review display comprises a display of an initial payment, and a monthly payment at least partially based on the specified time period, and the time period.

In some embodiments of the invention, the estimate review display comprises an early purchase option display comprising a user-definable early purchase option payment amount. In some embodiments, the at least one front end client comprises a web coupled device and the approval session and order sessions transmit to the customer over the Internet. In some embodiments, the at least one front end client comprises a kiosk device and the approval session and order session are displayed by the kiosk device.

Some embodiments of the invention include a computer-implemented method of generating and executing lease-purchases comprising providing a system for generating a lease-purchase agreement comprising a non-transitory computer-readable medium in data communication with at least one processor. The non-transitory computer-readable medium includes software instructions comprising a lease-purchase system and method which, when executed by the at least one processor, perform the process steps including coupling to at least one front end client comprising a customer interface where the customer interface comprises an approval session and order session. The approval session is configured to enable the customer to switch to the order session in the customer interface once approved. The process steps also include processing a customer application by launching a customer approval engine in the approval session, receiving customer information from a customer, and coupling to at least one verification server. The process steps also include instructing the at least one verification server to execute at least one verification of the customer based at least in part on the customer information, where the at least one verification server transmits at least one notification to the approval engine based on the at least one verification. The process steps further comprise determining an approval based at least in part on the at least one notification. Further, based on the approval, the process steps include optionally entering an order session and initiating an ordering engine to create a customer order. The process steps further include displaying at least one order selection page in the customer interface, and receiving order selection instructions from the customer for at least one good. The process steps also include coupling to at least one quote server, and instructing the at least one quote server to execute at least one quotation estimate based at least in part on the customer order, where the at least one quote server transmits to the ordering engine at least one quotation estimate. The process steps also include generating at least one lease agreement related to the at least one good by coupling to at least one agreement server, displaying at least one lease agreement in the customer interface, and receiving a customer signature or legally binding approval from the customer in the customer interface.

Some embodiments of the method further comprise software instructions which when executed by the at least one processor perform the process steps of entering a sales associate mode including generating and displaying at least one customer progress dashboard, displaying at least one customer order, and accepting input from a user to initiate the order from the at least one customer progress dashboard.

Some embodiments of the method further comprise software instructions which when executed by the at least one processor perform the process steps of displaying an estimate review display in the order session, where the estimate review display comprises a display of an initial payment, and a monthly payment at least partially based on the specified time period, and the time period, and an early purchase option display comprising a user-definable early purchase option payment amount. Further, the process steps enable the front end client to accept an initial payment for the at least one good, where the initial payment comprises a customer's credit card/debit account or electronic funds transfer or automated clearing house (“ACH”) payment. In some embodiments, the online payment solution account comprises at least one of ePay, Autopay, PayPal®, Apple Pay™, Google Wallet™, Amazon Payments, and Skrill payments.

In some embodiments of the method, the at least one front end client comprises a web coupled device and the approval session and order session transmit to the customer over the Internet. In some further embodiments of the method, the at least one front end client comprises a kiosk device and the approval session and order session are displayed by the kiosk device.

### DESCRIPTION OF THE DRAWINGS

FIG. 1 illustrates an overview of benefits provided by the lease-purchase system and method in accordance with embodiments of the invention.

FIG. 2 illustrates an overview of transactions steps of the lease-purchase system and method in accordance with some embodiments of the invention.

FIGS. 3A and 3B illustrate display screens of a lease-purchase system and method according to at least one embodiment of the invention.

FIG. 4 shows an example of a lease-purchase display screen for initiation of a lease-purchase in accordance with some embodiments of the invention.

FIG. 5A-5B illustrates a customer entry display screens of the lease-purchase system and method in accordance with some embodiments of the invention.

FIG. 6 illustrates a customer entry display screen of the lease-purchase system and method in accordance with some embodiments of the invention.

FIG. 7A illustrates a customer entry display screen of the lease-purchase system and method in accordance with some embodiments of the invention.

FIG. 7B illustrates a customer entry display screen of the lease-purchase system and method in accordance with some embodiments of the invention.

FIG. 8 illustrates an approval screen of the lease-purchase system and method in accordance with some embodiments of the invention.

FIG. 9 illustrates an order creation entry display screen of the lease-purchase system and method in accordance with some embodiments of the invention.

FIG. 10A illustrates a “pick a department” display screen of the lease-purchase system and method in accordance with some embodiments of the invention.

FIG. 10B illustrates a “pick a category” of the lease-purchase system and method in accordance with some embodiments of the invention.

FIG. 10C illustrates a “pick an item” of the lease-purchase system and method in accordance with some embodiments of the invention.

FIG. 11 illustrates an example of a product selection display screen of the lease-purchase system and method in accordance with some embodiments of the invention.

FIG. 12A illustrates an example of a product selection display screen of the lease-purchase system and method in accordance with some embodiments of the invention.

FIG. 12B illustrates an example of a product selection display screen of the lease-purchase system and method in accordance with some embodiments of the invention.

FIG. 13 illustrates a display screen showing excluded product types and dependencies of the lease-purchase system and method in accordance with some embodiments of the invention.

FIG. 14A illustrates an example of a create an order display screen of the lease-purchase system and method in accordance with some embodiments of the invention.

FIG. 14B illustrates an example of an order with price restriction display screen of the lease-purchase system and method in accordance with some embodiments of the invention.

FIG. 15A illustrates a review my estimate entry display screen of the lease-purchase system and method in accordance with some embodiments of the invention.

FIG. 15B illustrates another review my estimate display screen of the lease-purchase system and method in accordance with some embodiments of the invention.

FIG. 16A illustrates an early option display screen of the lease-purchase system and method in accordance with some embodiments of the invention.

FIG. 16B illustrates another early option selection display screen of the lease-purchase system and method in accordance with some embodiments of the invention.

FIG. 17 illustrates an initial payment review display screen of the lease-purchase system and method in accordance with some embodiments of the invention.

FIG. 18 illustrates a review estimate monthly payment screen of the lease-purchase system and method in accordance with some embodiments of the invention.

FIG. 19 illustrates an example of an associate mode display screen of the lease-purchase system and method in accordance with some embodiments of the invention.

FIG. 20 illustrates a customer progress display screen of the lease-purchase system and method in accordance with some embodiments of the invention.

FIG. 21 illustrates an associate mode order confirmation of the lease-purchase system and method in accordance with some embodiments of the invention.

FIG. 22 illustrates an associate mode pick up/delivery and invoice entry display screen of the lease-purchase system and method in accordance with some embodiments of the invention.

FIGS. 23A and 23B illustrate an associate mode pick up/delivery and invoice process of the lease-purchase system and method in accordance with some embodiments of the invention.

FIG. 24 illustrates an electronic signature display screen of the lease-purchase system and method in accordance with some embodiments of the invention.

FIG. 25 illustrates a rental purchase agreement display screen of the lease-purchase system and method in accordance with some embodiments of the invention.

FIG. 26 illustrates an initial payment process display screen of the lease-purchase system and method in accordance with some embodiments of the invention.

FIG. 27 illustrates a payments ePay and AutoPay display screen of the lease-purchase system and method in accordance with some embodiments of the invention.

FIG. 28 illustrates a lease-purchase process overview of the lease-purchase system and method in accordance with some embodiments of the invention.

FIG. 29 illustrates a system framework of the lease-purchase system and method in accordance with some embodiments of the invention.

FIG. 30 illustrates a computer system for operating and processing components of the lease-purchase system and method in accordance with some embodiments of the invention.

FIG. 31 illustrates an overview of the customer acceptance engine of the lease-purchase system and method in accordance with some embodiments of the invention.

FIG. 32 illustrates a lease-purchase system and method detailed system architecture in accordance with some embodiments of the invention.

FIGS. 33-35 illustrate a lease-purchase system and method customer acceptance sequence diagram in accordance with some embodiments of the invention.

FIGS. 36-43 illustrate a lease-purchase system and method process flow diagram in accordance with some embodiments of the invention.

FIG. 44A illustrates an example of customer approval engine logic of the lease-purchase system and method in accordance with some embodiments of the invention.

FIG. 44B illustrates an example of logic used for a customer credit evaluation for the lease-purchase system and method in accordance with some embodiments of the invention.

FIG. 45 illustrates a services requirements analysis of the lease-purchase system and method in accordance with some embodiments of the invention.

FIG. 46 illustrates a front-end security coordination of the lease-purchase system and method in accordance with some embodiments of the invention.

FIG. 47 illustrates a security keys display of the lease-purchase system and method in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As used herein, a customer can include a potential or pending customer or multiple customers. Further, the customer can also include one or more actual customers. The customer can comprise an individual or a group of individuals. The customer or customers can represent themselves, or the customer or customers can be representatives of a company or group of companies.

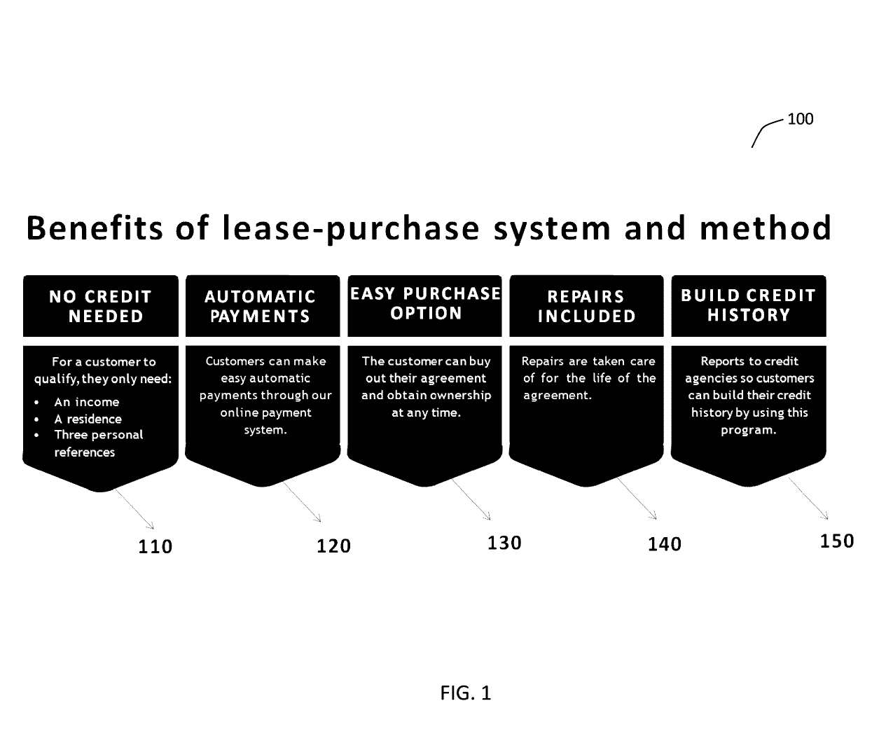

In some embodiments of the invention, the lease-purchase system and method can provide customer benefits guided by various principles of operation. For example, FIG. 1 illustrates an overview of benefits 100 provided by the lease-purchase system and method in accordance with some embodiments of the invention.

In some embodiments of the invention, the lease-purchase system and method can provide customer benefits by operating under at least five guiding principles of operation (shown in FIG. 1 as principles 110, 120, 130, 140, and 150). For example, in some embodiments, the lease-purchase system and method can provide benefits to a customer by offering at least one product without a minimum qualifying credit score. In some embodiments, the lease-purchase system and method can provide benefits to a customer by offering at least one product to the customer, subject the terms of a lease-purchase agreement with the option of making or establishing automated payments to meet the renewal obligations of the lease-purchase agreement. Further, in some embodiments of the invention, the lease-purchase system and method can provide benefits to a customer by allowing the customer to obtain use of a product, with an option to acquire ownership of that product, through a lease-purchase agreement. Some embodiments include a lease-purchase system and method that can provide benefits to a customer by offering included maintenance and/or repair as part of the lease-purchase agreement. Further, the lease-purchase system and method can provide benefits to a customer by allowing the customer to build his or her credit history by making timely payments under the lease-purchase agreement where transactional history can be reported to credit reporting agencies.

Using one or more of the methods described herein, the lease-purchase system and method can couple with systems or methods of one or more vendors or suppliers to enable customers to gain access to goods and services who do not qualify for traditional financing or do not wish to accumulate debt or impair available credit. In some embodiments of the invention, orders, contracts, and customer agreements can be developed by the lease-purchase system and method, reviewed, and accepted by a customer using electronic signature. For a customer to qualify, the customer can provide his or her income, a residence, and a pre-determined number of personal references. The lease-purchase system and method can enable customers to automate payments owed under their lease-purchase agreement and offer customers the ability to acquire ownership pursuant to the terms of the lease-purchase agreement. Further, where repairs are included, the lease-purchase system and method can manage repairs of any lease-purchased product for the life of the agreement. Moreover, by entering into a lease-purchase agreement for one or more products, the lease-purchase system and method can report behavior to credit agencies, where permitted, so that customers can build their credit history.

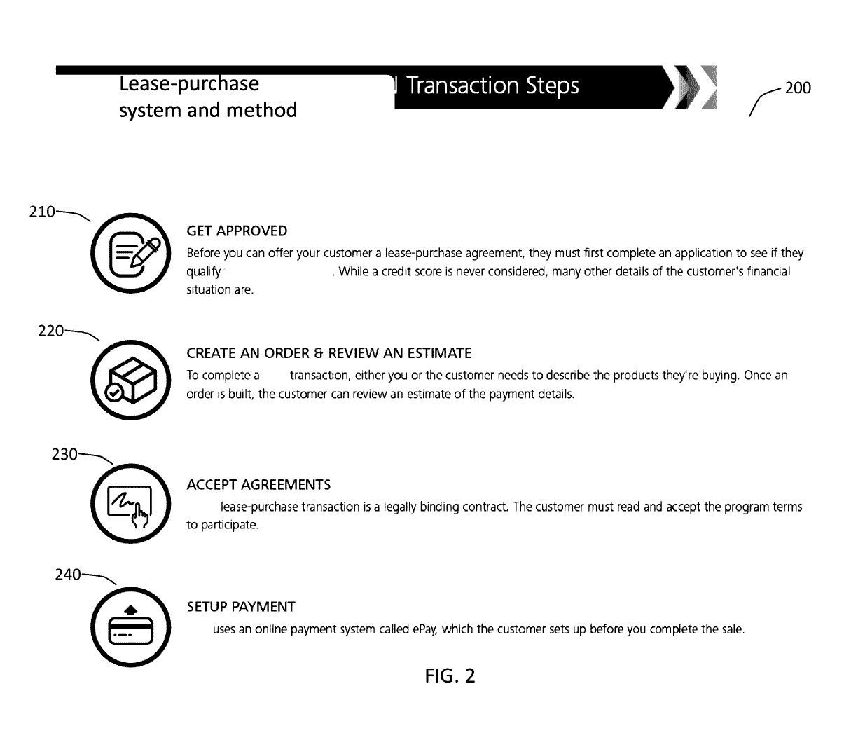

In some embodiments, the lease-purchase system and method can process customer transactions using a series of transaction steps. For example, FIG. 2 illustrates an overview of transactions steps 200 of the lease-purchase system and method in accordance with some embodiments of the invention. In some embodiments of the invention, the transaction steps 200 can include “get approved” 210, “create an order and review an estimate” 220, “accept agreements” 230, and “setup payment” 240. As shown by the steps, before a customer can apply and complete a lease-purchase agreement, the customer must first complete a lease order/application (step 210). Once a customer receives approval, the customer can create and apply for a product, and receive and review an estimate for one or more products (step 220). The customer can then accept a lease-purchase transaction by accepting and entering into a lease-purchase contract (step 230). In some embodiments, payment for the selected goods can be setup by the customer prior to completion of the transaction (e.g., using an online payment solution such as ePay) (shown as step 240). Further, the transactions steps 200 of the lease-purchase system and method can apply to multiple agreements per customer where the customer engages the lease-purchase system and method for more than one lease-purchase transaction using a plurality of agreements.

In some embodiments, the lease-purchase system and method can be operated and accessed using one or more front end clients configured to engage or re-engage with at least one user with one or more sessions through one of a number of different interfaces. For example, in some embodiments, the lease-purchase system and method can include a front end client comprising a touch-screen type kiosk. The kiosk can comprise at least one graphical user interface display (“GUI”) to enable the lease-purchase system and method to display information to the customer, and to enable the customer to select and/or input information into the lease-purchase system and method within one or more sessions. Other embodiments of the invention can include a front end client comprising one or more web portals coupled to a lease-purchase system and method comprising at least one GUI displaying information to the customer within at least one web portal session, and enabling the customer to select and/or input information into the lease-purchase system and method within one or more web portal sessions. Other embodiments of the invention can include a front end client comprising one or more web portals coupled to a lease-purchase system and method sales associate. In some embodiments, a complete transaction can proceed through a single GUI, whereas in other embodiments, the complete transaction can be completed through multiple GUI's. For example, in some embodiments, a customer transaction can be completed using the aforementioned touch-screen type kiosk. In some other embodiments, the transaction can be completed using two or more GUI's (e.g., using the touch-screen kiosk type GUI and one or more web portals coupled to a lease-purchase system and method sales associate). In some embodiments, any session configured by the lease-purchase system and method (i.e., through a web portal and/or through a kiosk) can include an auto-renew session token to prevent a time-out of any session (e.g., such as an in-store virtual approval).

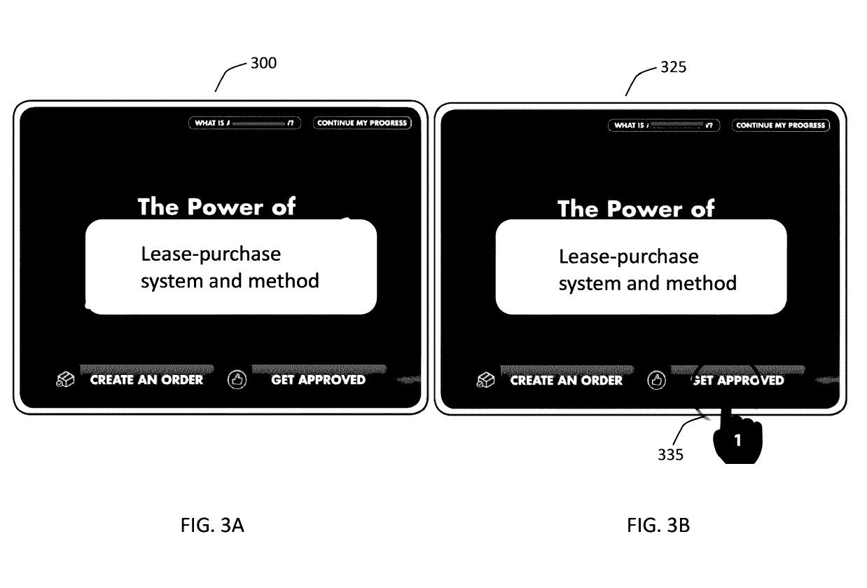

In some embodiments, the lease-purchase system and method can render at least one GUI as one or more display screens. For example, FIGS. 3A and 3B illustrate display screens 300, 325 generated and rendered by the lease-purchase system and method according to at least one embodiment of the invention. In some embodiments, the lease-purchase system and method can display a menu screen including “create an order” and “get approved” access icons. As depicted in FIG. 3B, a customer seeking approval through the lease-purchase system and method can select or click on the “get approved” access icon to move forward with approval process (shown as action 335 in FIG. 3B). Following selection of the “get approved” access icon, the lease-purchase system and method can begin a lease-purchase approval process.

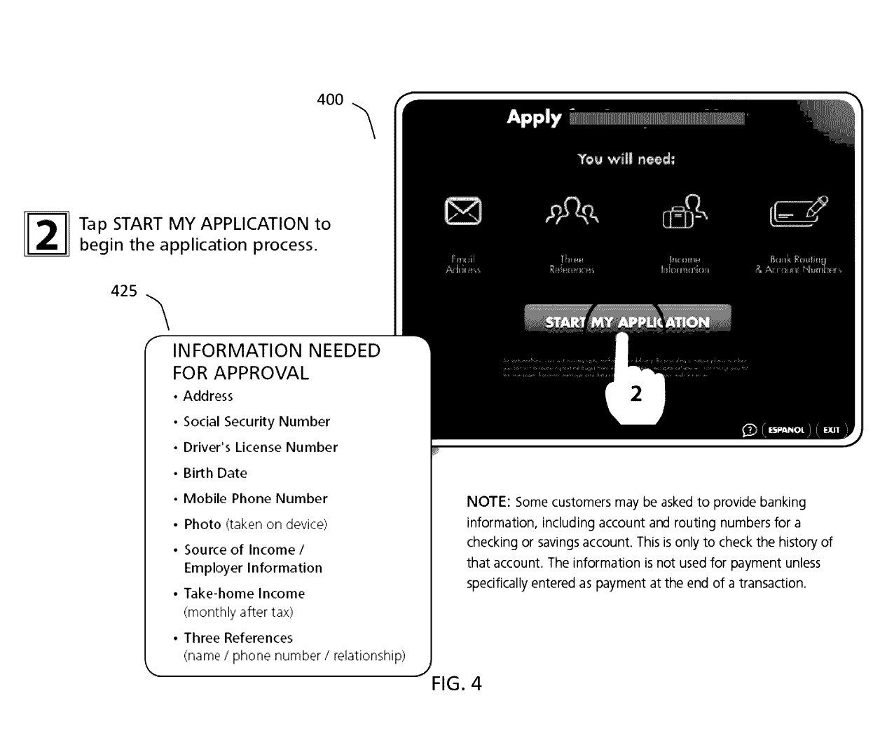

FIG. 4 shows an example of a lease-purchase display screen 400 for initiation of a lease-purchase transaction in accordance with some embodiments of the invention. In some embodiments, the initiation display screen 400 can include instructions to the customer detailing what will be required during the application process (shown as 425). In other embodiments, the instructions can be provided on previously displayed screens, or sent to the customer using other means (such as by email or by postal mail). For example, in some embodiments, the lease-purchase system and method can require an email address or physical address of the customer. The lease-purchase system and method can also require a pre-determined number of references, income information, and banking information such as bank routing and account numbers. In some embodiments, the lease-purchase system and method can also require the customer provide his or her Social Security number, driver's license number, birth date, mobile phone number, photo (taken on device), source of income/employer information, and take-home income (e.g., monthly income after tax).

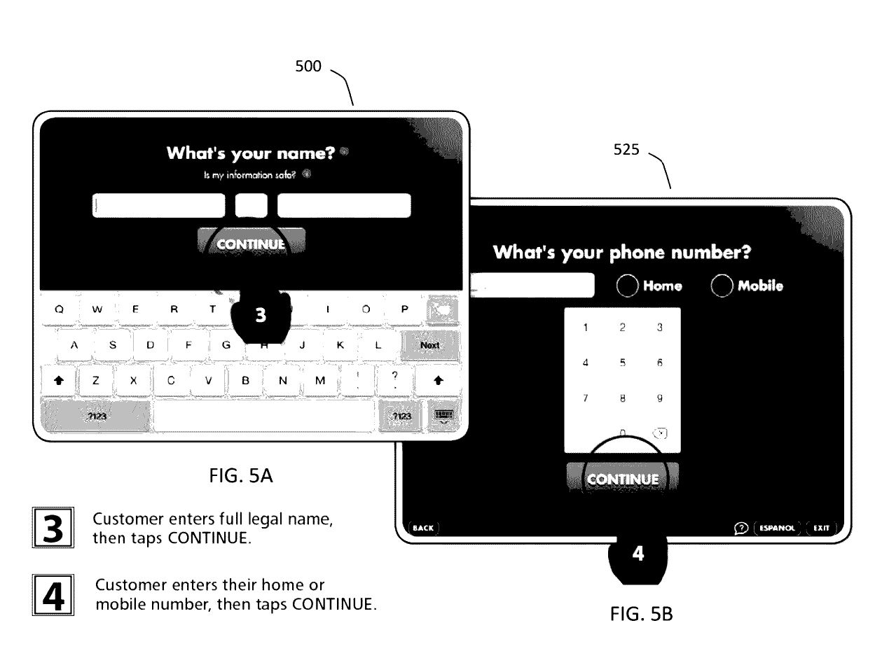

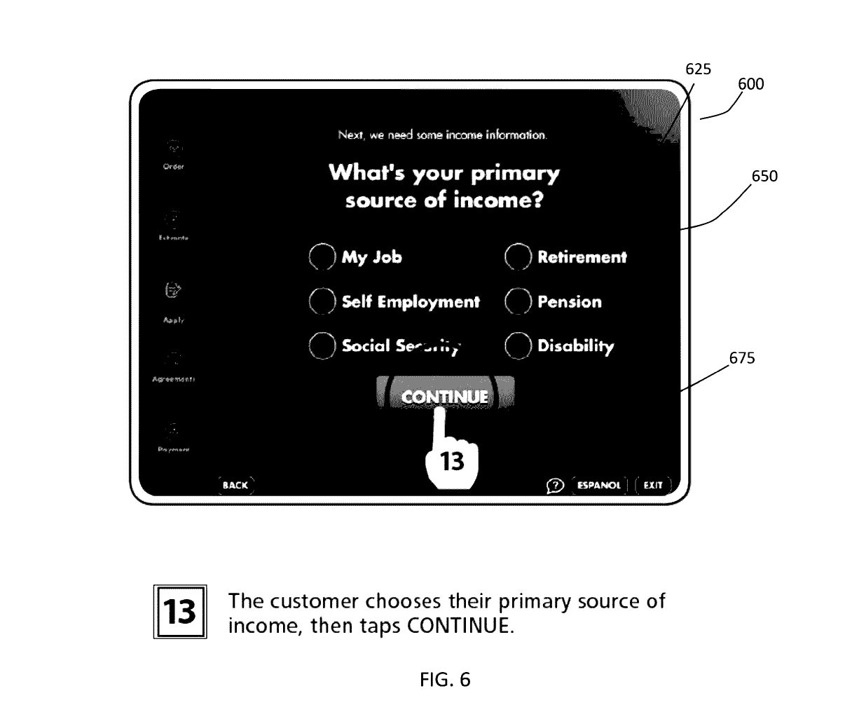

Examples of display screens depicting entering of customer information can be seen in FIGS. 5A-5B, and FIGS. 6, and 7A-7B. For example, FIG. 5A illustrates a customer entry display screen 500 of the lease-purchase system and method depicted entry of customer name, and FIG. 5B illustrates a customer entry display screen 525 of the lease-purchase system and method which depicts entry telephone information. Further, FIG. 6 illustrates a customer entry display screen 600 of the lease-purchase system and method structured to receive information related to the customer's primary source of income. In some embodiments, the display screen 600 of FIG. 6 can comprise one or more questions 625 related to the customer's primary source of income, and a display of a plurality of selectable answers 650 related to that question. In some embodiments, the selectable answers 650 can include sources directly related to the customer's employment (“my job” and “self-employment”). Further, in some embodiments, other selectable options for primary income can include income from a variety sources including, but not limited to, Social Security, retirement, pension, and disability. Once a customer has selected one or more entries of sources of primary income, the customer can select or click “continue” to proceed to subsequent steps of the approval process (depicted as user action 675). In some embodiments of the invention, any income within or above a specified value can be reviewed by an associate within an associate mode. For example, in some embodiments, any income considered as high can be reviewed by an associate within an associate mode.

In some embodiments, the lease-purchase system and method can enable customer information to be entered electronically. For example, in some embodiments, the lease-purchase system and method can accept customer information from a scanned barcode (e.g., from a barcode at the back of a customer's driver's license). In some embodiments, the lease-purchase system and method can scan a barcode. For example, in some embodiments, aforementioned touch-screen type kiosk can include a barcode reader configured to read customer information from a barcode. In some embodiments, the scanned information can include the name, address, date of birth, and the driver's license number.

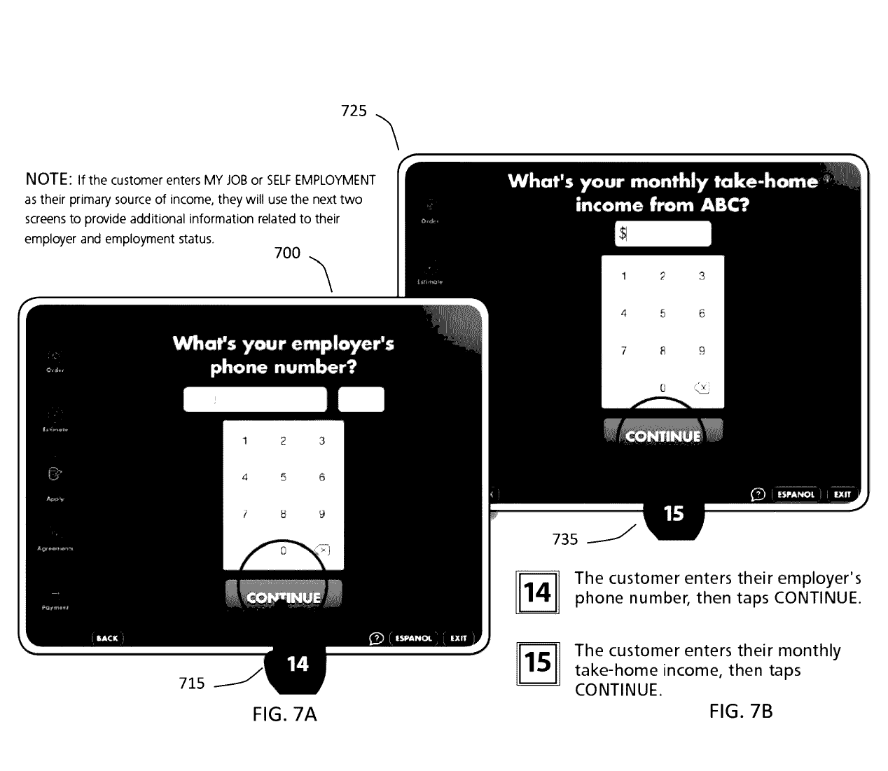

In some embodiments, the customer can be prompted to provide employer information. This can occur regardless of whether the customer has previously selected his or her employer as a primary source of income. For example, FIG. 7A illustrates a customer entry display screen 700 of the lease-purchase system and method in accordance with some embodiments of the invention. Using this screen, the customer can enter the employer's phone number and extension and continue (shown as action 715). Further, in some embodiments, lease-purchase system and method can display an entry screen to enable the customer to enter salary information. For example, FIG. 7B illustrates a customer entry display screen 725 of the lease-purchase system and method configured to enable a customer to enter a monthly take-home income and continue (shown as action 735).

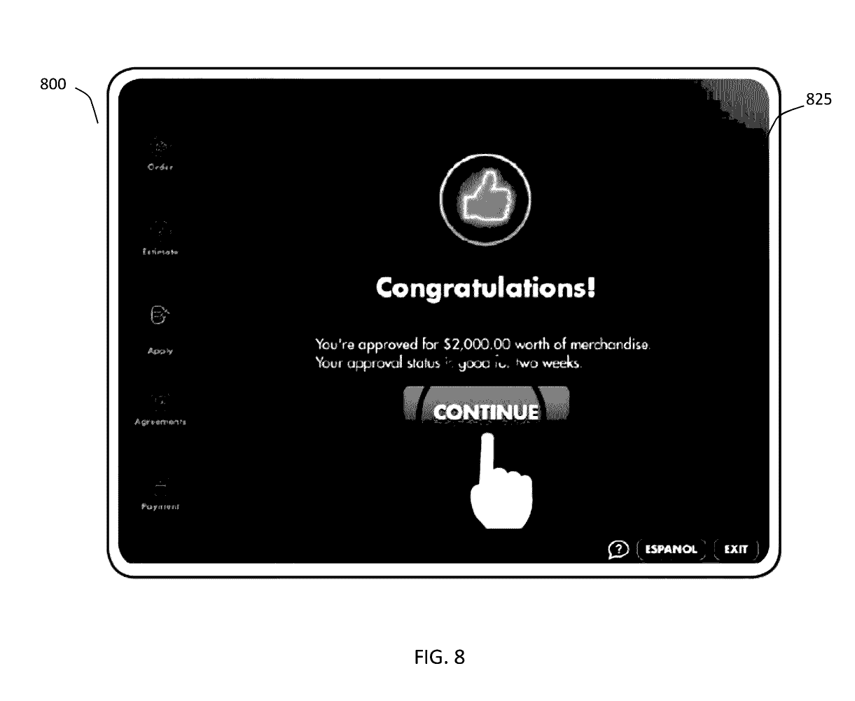

In some embodiments, following approval, the lease-purchase system and method can provide an announcement display that can include an approved fund amount for merchandise (e.g., such as goods and services). For example, FIG. 8 illustrates an approval display screen 800 of the lease-purchase system and method in accordance with some embodiments of the invention. In some embodiments, following approval, the lease-purchase system and method can display an announcement display such as a “congratulations” display 825.

In some embodiments, a customer can engage or re-engage with the lease-purchase system and method at various times and at various stages in the approval or lease purchase process. For example, in some embodiments, a customer can engage or re-engage with the lease-purchase system and method after applying for approval (either from the same location or during another session and/or location). In this instance, if the lease-purchase system and method has no record of customer's email address, the lease-purchase system and method can request a customer email address.

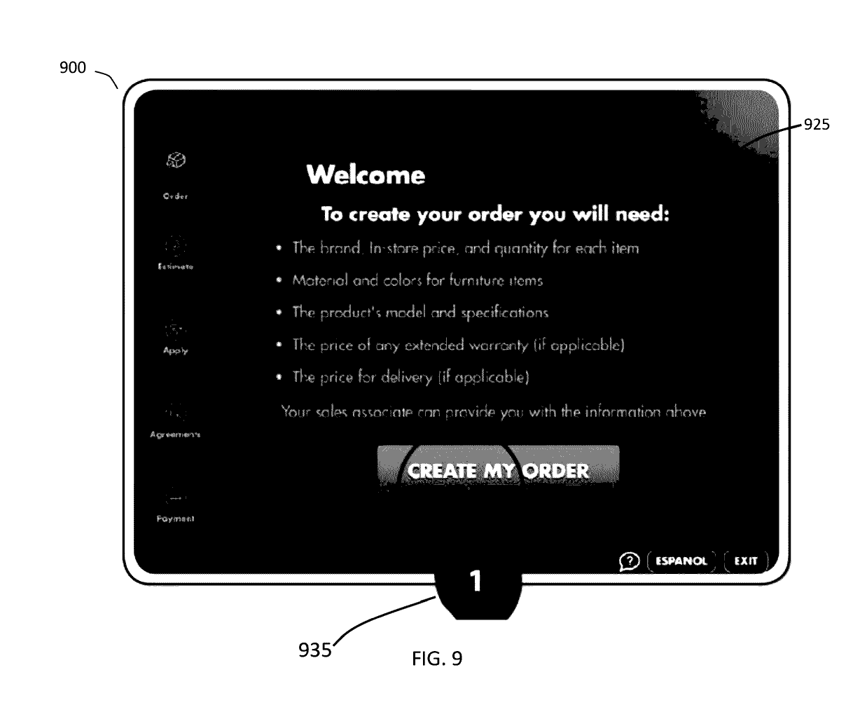

In some embodiments of the invention, following notification of approval, the lease-purchase system and method can display an order creation display screen. For example, FIG. 9 illustrates an order creation entry display screen 900 of the lease-purchase system and method in accordance with some embodiments of the invention. In some embodiments, the order creation entry display screen can include information related to required information from the customer to create the order (shown as list 925). For example, in some embodiments, the lease-purchase system and method can prompt the customer for the desired brand, in-store price, and quantity for each item of merchandise. Further, in some embodiments, the lease-purchase system and method can prompt the customer for desired material and colors for furniture items. In some further embodiments, the lease-purchase system and method can prompt the customer for the desired product's model, model number and specifications. In some embodiments, the lease-purchase system and method can prompt the customer for the price of any extended warranty or service plan (if applicable). Further, in some embodiments of the invention, the lease-purchase system and method can prompt the customer for the location and/or price of delivery (if applicable). In some embodiments, following display of list 925, the lease-purchase system and method can enable the customer to begin the order creation process by selecting or clicking “create my order” (shown as action 935).

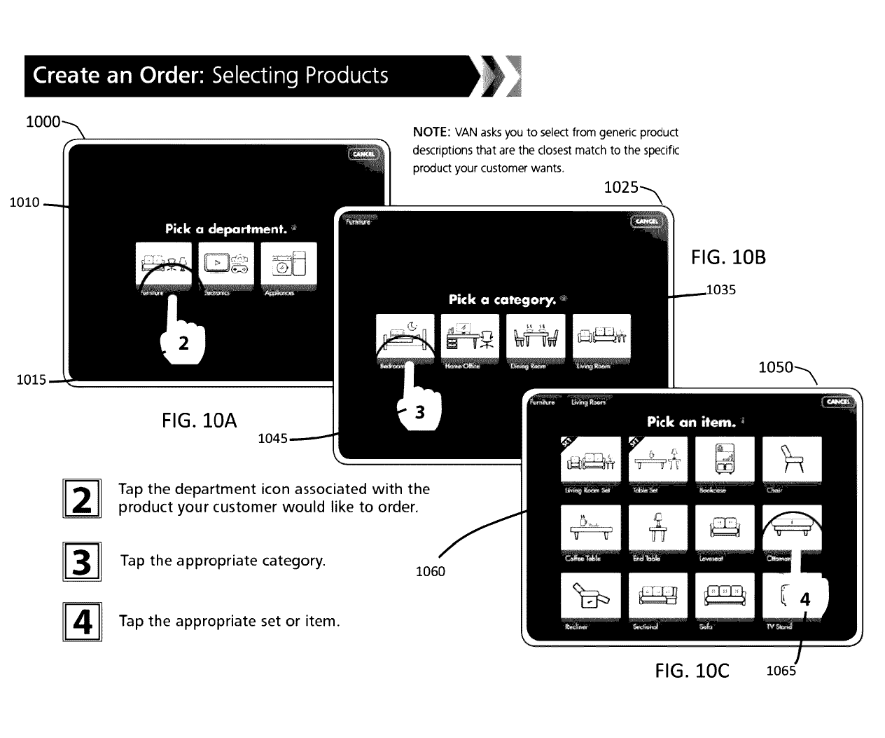

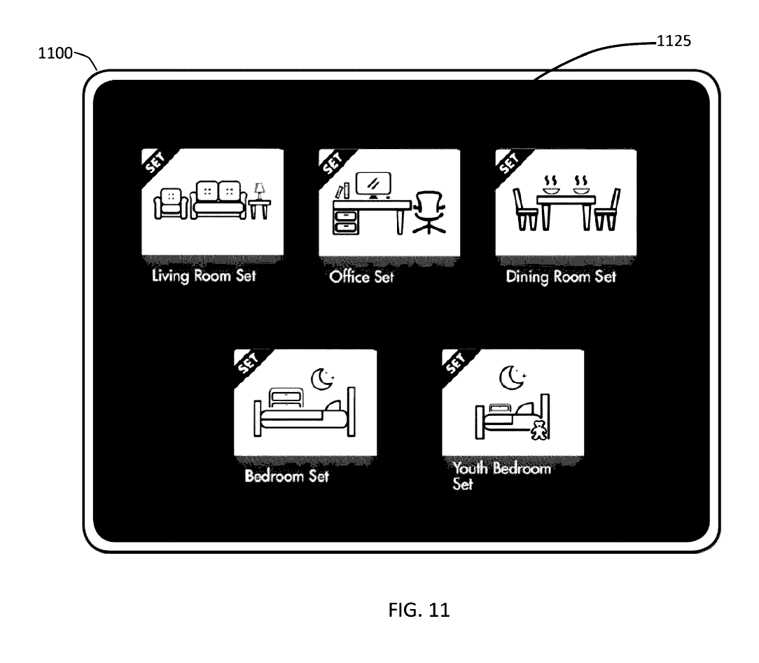

In some embodiments of the invention, the lease-purchase system and method can provide a number of display screens to enable a customer to select one or more products for the lease-purchase transaction. For example, FIG. 10A illustrates a “pick a department” display screen 1000 of the lease-purchase system and method in accordance with some embodiments of the invention. Using one or more department icons 1010, the customer can select a department from which to select products or services (using selection action 1015). Further, FIG. 10B illustrates a “pick a category” display screen 1025 of the lease-purchase system and method in accordance with some embodiments of the invention. In some embodiments, the customer can select a category of products or services (using selection action 1045). In some embodiments, after the customer selects a department and category, the customer can select an item. For example, FIG. 10C illustrates a “pick an item” display screen 1050 of the lease-purchase system and method in accordance with some embodiments of the invention. As illustrated, to select any of the aforementioned icons, the customer can click or tap the icon associated with the specific department, category or item (selection action 1065).

Selectable icons displayed by the lease-purchase system and method can include icons that comprise text, graphics, or a combination thereof. In some embodiments, icons can be displayed representing a selectable department, category, or item. For example, in some embodiments, icons displayed in FIG. 10A can comprise department icons depicting “furniture”, “electronics”, and/or “appliances”. Further, icons displayed in FIG. 10B can include category icons comprising “bedroom”, “home” office”, “dining room”, and “living room”. In some embodiments, item icons displayed in FIG. 10C can comprise “living room set”, “table set”, “bookcase”, “chair”, “coffee table”, “end table”, “love seat”, “ottoman”, “recliner”, “sectional”, “sofa”, and “TV stand”. In some embodiments, the above described icons can include graphical representations as shown. In other embodiments, the icons can include the text name of the selectable department, category or item in addition to the graphical item.

In some embodiments, the customer can select one or more bundles of goods (i.e., at least two goods). As an example, furniture stores often sell multiple items that are bundled under a single price (e.g., a living room group or dinette set). To accommodate this, the lease-purchase system and method can display one or more icons to enable a user to select a set or group for lease-purchase using a single icon. For example, FIG. 11 illustrates an example of a product selection display screen 1100 of the lease-purchase system and method in accordance with some embodiments of the invention. In some embodiments, the above described icons can include graphical representations, text descriptions, or combinations of both as described above. In some embodiments, the icons representing bundles or groups of articles can include living room set, office set, dining room set, bedroom set, and/or youth bedroom set (shown as icons 1125). In some embodiments, the customer can select any one or more of these icons to proceed with the transaction.

In some embodiments, when making a product selection, the lease-purchase system and method can prompt the user for additional information to help describe an item in more detail. In some embodiments, if there is no direct match, the user can select an item that represents the closest match.

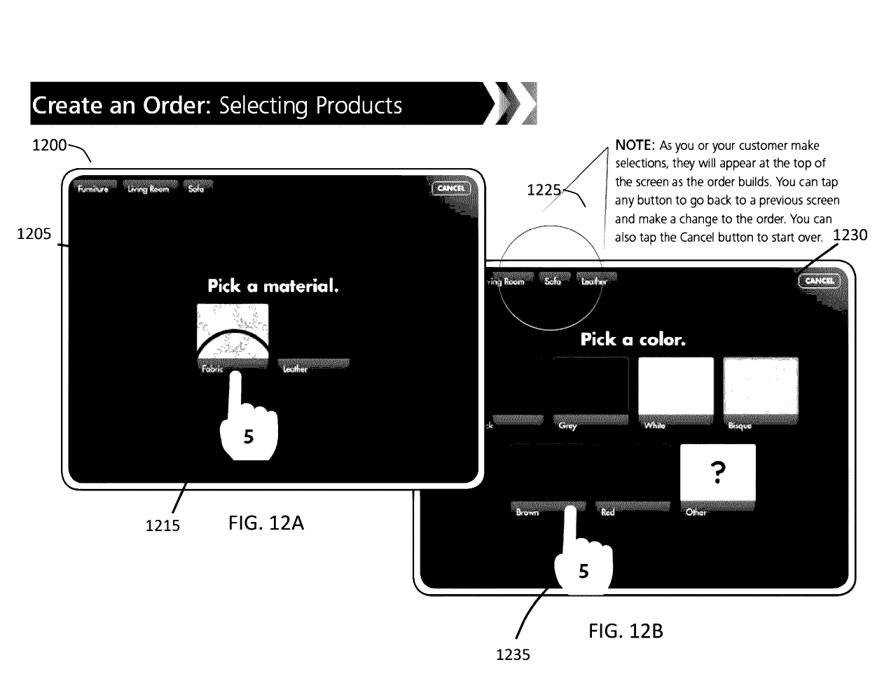

In some embodiments, the lease-purchase system and method can enable a customer to select one or more product specifications. For example, FIGS. 12A-12B illustrate examples of product selection display screens 1200, 1225 of the lease-purchase system and method in accordance with some embodiments of the invention. Some embodiments include a visual display of a user's product selection. For example, referring to FIGS. 12A and 12B, in some embodiments, the lease-purchase system and method can display icons 1205, 1230 representing user selectable product specifications. As the user continues to select products, the lease-purchase system and method can display further icons signifying the selected products. The user can also go back to a previous page at any time, or change or cancel any selection on current or prior display screens. The example display screen 1200 shown in FIG. 12A illustrates a user selection (selection action 1215) of a material product (fabric selection from a choice of fabric and leather). FIG. 12B shows a user selection of a color (of the selected fabric), and depicts a user selection (selection action 1235) of a brown color from a choice selection of black, grey, white, bisque, brown, red, and “other” (e.g., where the user can select from a palette of colors not represented in the display screen 1225).

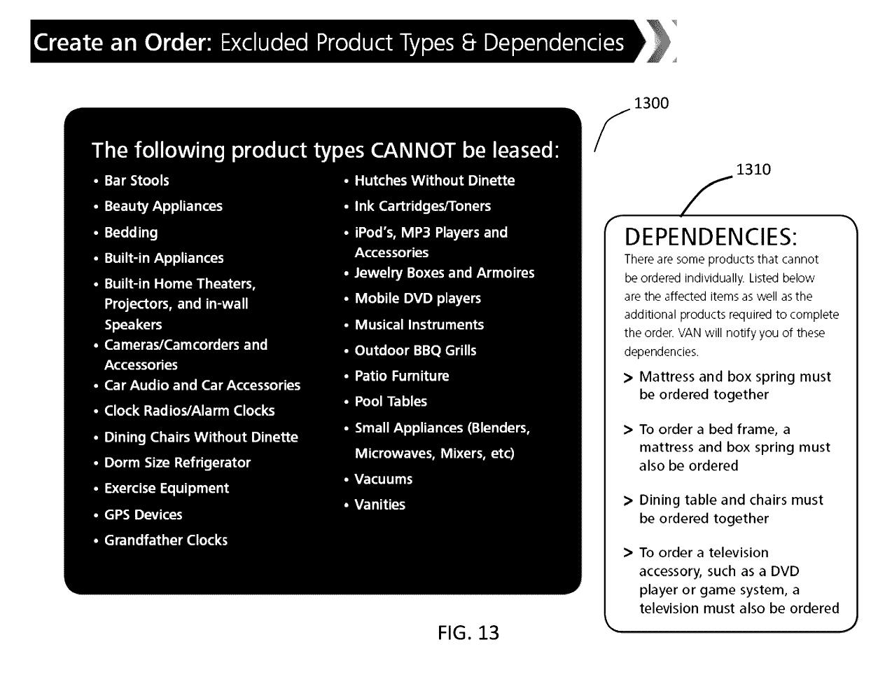

In some embodiments of the invention, the lease-purchase system and method can display restrictions to lease-purchase selections. For example, FIG. 13 illustrates a display screen 1300 showing excluded product types and dependencies of the lease-purchase system and method in accordance with some embodiments of the invention. In some embodiments, products can be excluded from lease-purchase eligibility, and the user can be notified of these exclusions. Some embodiments include lease-purchase exclusion and lease-purchase dependencies. For example, in some embodiments, specific products cannot be ordered individually. Examples shown in FIG. 13 (list 1310) include a mattress and box springs that cannot be ordered separately, ordering a bed-frame must include a mattress and box spring, a dining table and chairs must be ordered together, and television accessories must be ordered with a television.

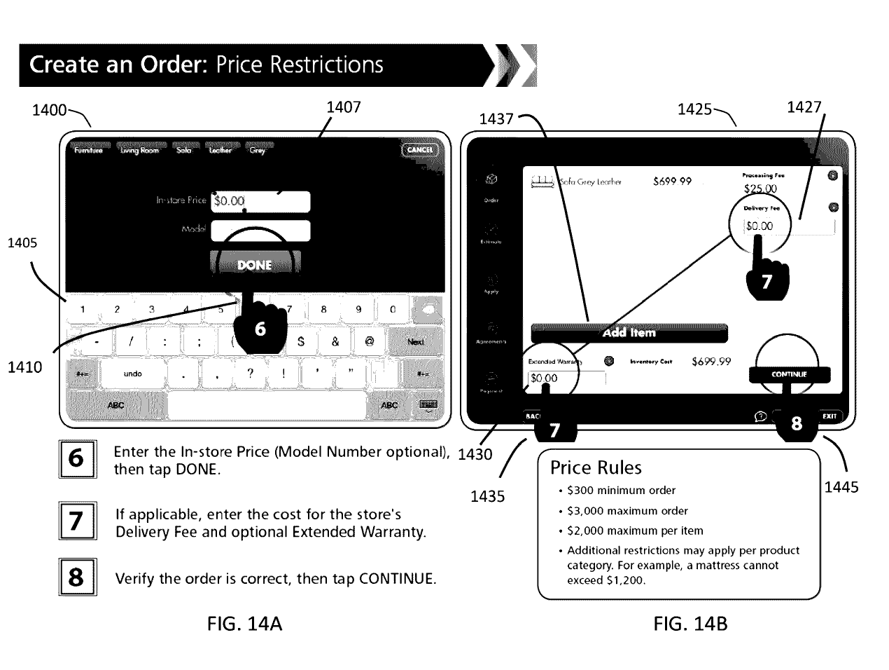

FIG. 14A illustrates an example of a create an order display screen 1400 of the lease-purchase system and method in accordance with some embodiments of the invention. In some embodiments, the lease-purchase system and method can enable a user to enter information related to price, product model number, delivery fee and extended warranty cost of one or more selected products. For example, in some embodiments, the lease-purchase system and method can display a virtual keyboard 1405 to enable a user to enter information that can be displayed to the user on the display screen. As illustrated, in some embodiments, the lease-purchase system and method can enable a user to enter an in-store price and/or a model number of a product (e.g., within entry window 1407). In some embodiments, if the product requires a delivery fee, or an optional extended warranty is available, the user or the system and method can input the associated costs. The user can then use the display screen 1400 to verify the order (e.g., by tapping a ‘done’ icon) (shown as action 1410).

In some embodiments, the lease-purchase system and method can manage at least one price rule associated with one or more products or groups of products. For example, in some embodiments, the lease-purchase system and method can manage a minimum price order (e.g., a $300 minimum order). In some further embodiments, the lease-purchase system and method can manage a maximum price order (e.g., a $3000 maximum order). In other embodiments, the lease-purchase system and method can manage a maximum price per item (e.g., a $2000 maximum per item). Further, some embodiments can include additional restrictions that can be applied per product category. For example, a mattress cannot exceed a specific price such as $1200. FIG. 14B illustrates an example of an order with price restriction display screen 1425 of the lease-purchase system and method in accordance with some embodiments of the invention. In some embodiments, the previously mentioned delivery fee (entry window 1427) and extended warranty fee (entry window 1430) can be entered and shown in the display screen 1425. Further, the user can continue to add further items during the lease-purchase event, and any processing fee can be displayed along with a total cost (see add item action icon 1437). Once all items have been added to the transaction, the user can continue (action 1445).

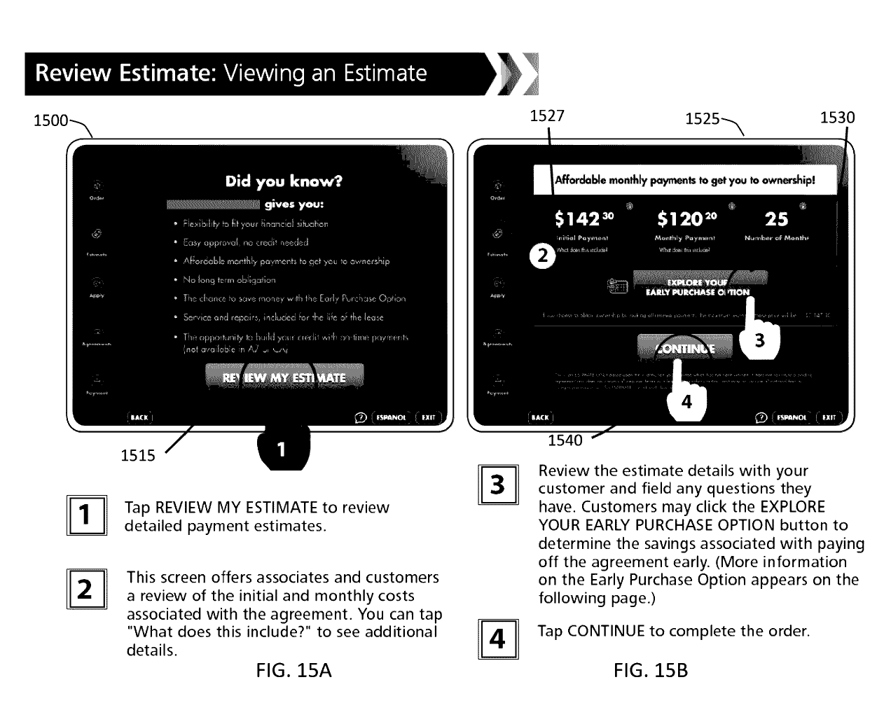

In some embodiments of the invention, the lease-purchase system and method can enable a user to review an estimate of any current or pending lease-purchase. For example, FIG. 15A illustrates a review my estimate entry display screen 1500 of the lease-purchase system and method in accordance with some embodiments of the invention. Further, FIG. 15B illustrates a review my estimate display screen 1525 of the lease-purchase system and method in accordance with some embodiments of the invention. In some embodiments, the lease-purchase system and method can provide an icon to review an estimate. As depicted in FIG. 15A, a user can tap a “review my estimate” icon (1515) to proceed with the estimate review process. In some embodiments, the lease-purchase system and method can also display a review of initial and monthly costs associated with any lease-purchase agreement.

Referring to FIG. 15B, in some embodiments, the lease-purchase system and method can tap a “what does this include” icon (1527) to access and review additional details of the agreement. Further, the lease-purchase system and method can enable the user to review the estimate details and field any questions. In some embodiments, the lease-purchase system and method can enable a user to review projected costs based on an early purchase option. For example, in some embodiments, the user can examine estimates related to an early purchase option. The user can click on an “explore your early purchase option” (icon 1530) to configure the lease-purchase system and method to display early purchase options, and display potential savings associated with exercising the early purchase option provided in the lease-purchase agreement.

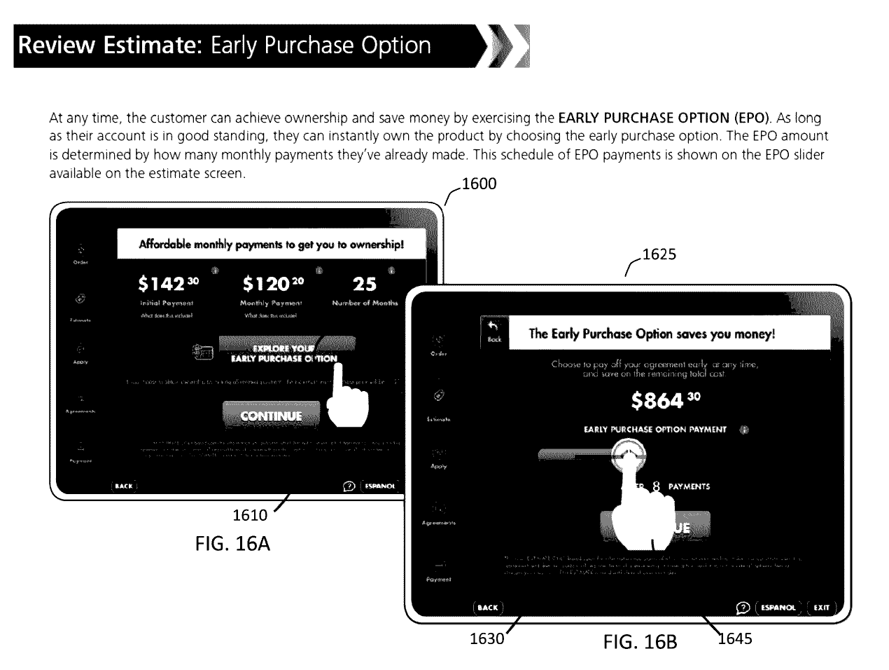

FIG. 16A illustrates an early purchase option display screen 1600 of the lease-purchase system and method in accordance with some embodiments of the invention, and FIG. 16B illustrates another early option selection display screen of the lease-purchase system and method in accordance with some embodiments of the invention. In some embodiments, at any time, the user (such as a customer) can achieve ownership of one or more leased-purchased products by exercising an early purchase option (“EPO”). As long as the user's lease-purchase agreement is in good standing, the user can obtain ownership of the product(s) under the terms of the lease-purchase agreement. The EPO payment amount can be determined in accordance with a calculation determined, in part, by reference to the amount of rent paid to date or remaining term of the agreement. As illustrated in FIG. 16A, in some embodiments, the lease-purchase system and method can display an initial payment cost and/or a monthly payment and/or the total number of payments of the lease-purchase with no early purchase, and can show an estimated early purchase option payment. Further, the user can select one or more numbers of payments to review the early purchase option cost as a function of the number of payments completed (selection action 1610). As shown in FIG. 16B, after a user selects the EPO, the lease-purchase system and method can display a payment slider 1630 to enable the user to alter the number of payments (using selection action 1645). The lease-purchase system and method can then calculate a new payment amount based on the remaining total cost of the early purchase and the selected number of payments selected by the user.

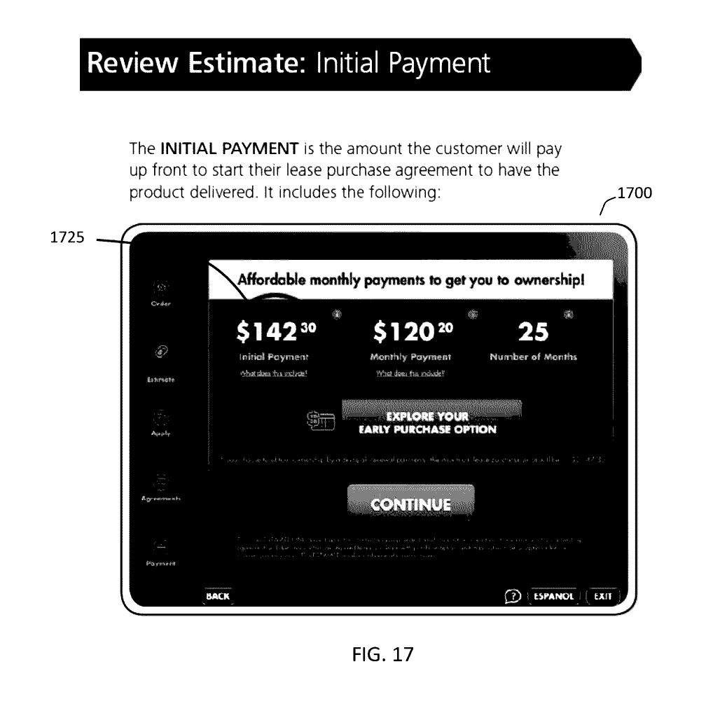

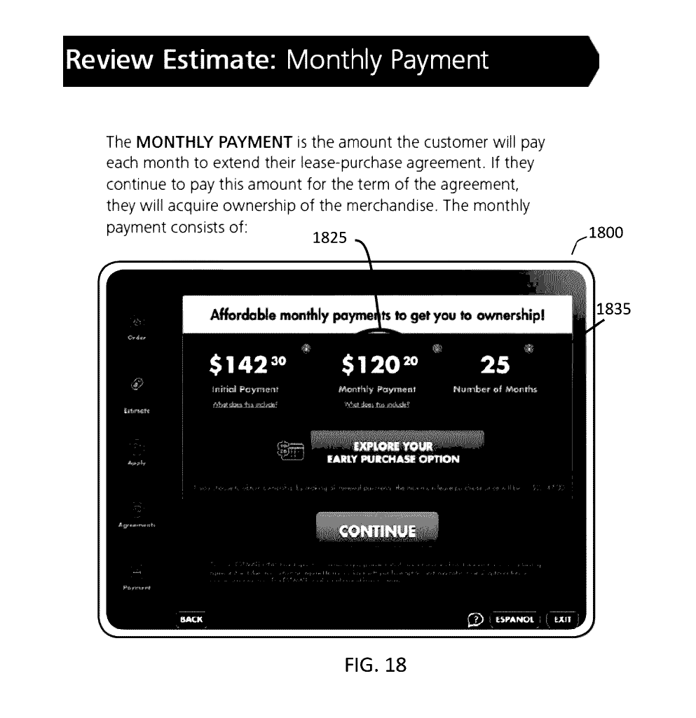

In some embodiments, a user can review a monthly payment cost and schedule. For example, FIG. 17 illustrates an initial payment review display screen 1700 of the lease-purchase system and method in accordance with some embodiments of the invention. In some embodiments, the lease-purchase system and method can display costs associated with a lease-purchase of one or more products. This can include an initial payment 1725 (i.e., the initial payment will pay on an up-front basis to start the lease-purchase agreement and to have the lease-purchased products delivered), a monthly payment amount (shown circled in FIG. 18 and marked as 1825), and the total number of payments over which the lease-purchase is agreed (shown as number of payments 1835). As mentioned above, the user can be enabled by the lease-purchase system and method to obtain ownership of the products prior to completion of the full term of the lease-purchase agreement using the EPO. In some embodiments, the user can make a final lump-sum payment to complete the lease-purchase payments.

In some embodiments, the user of the lease-purchase system and method can be a customer or a sales associate. For example, in some embodiments, any of the aforementioned display screens shown in FIGS. 3A-3B, 4, 5A-5B, 6, 7A-7B, 8-9, 10A-10C, 11, 12A-12B, 13, 14A-14B, 15A-15B, 16A-16B, 17-18 can be rendered based on information provided to the lease-purchase system and method by a customer or a sales associate. If the user is a sales associate, the user can operate the lease-purchase system and method and enter information at least partially based on information provided by customer. Some further embodiments of the invention can comprise modules, components, or modes of the lease-purchase system and method that can be used solely by the sales associate.

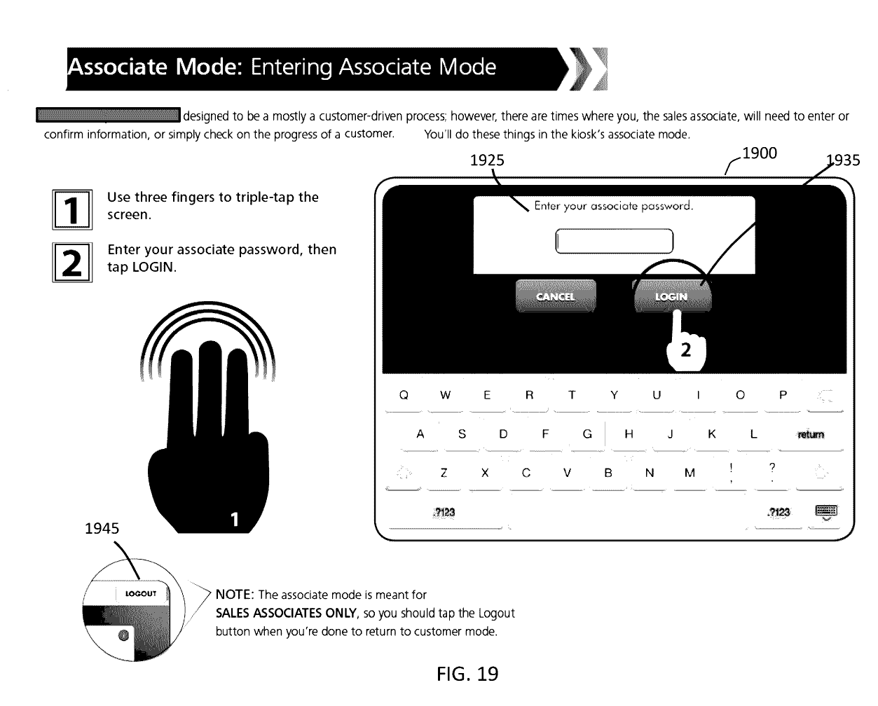

For example, FIG. 19 illustrates an example of an associate mode display screen 1900 of the lease-purchase system and method in accordance with some embodiments of the invention. In some embodiments of the invention, a sales associate can enter an associate mode of the lease-purchase system and method by entering a password (password entry 1925). The lease-purchase system and method can then enter the sales associate into the associate mode (login selection action 1935). At any time, the lease-purchase system and method can enable the sales associate to log out of the associate mode (and thus returning to a mode operable by the sales associate or a customer) using the logout icon 1945. At any time, and after completion of an associate mode session, the user can log out of the associate mode and return to the customer mode and/or log out of the lease-purchase system and method.

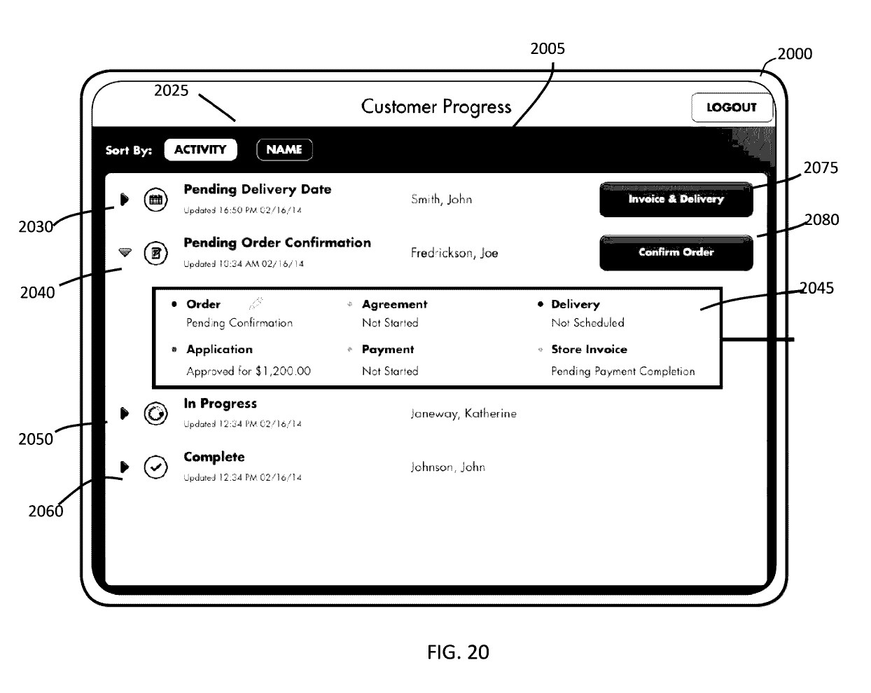

While operating in the associate mode, the lease-purchase system and method can enable a sales associate to review one or more parameters related to one or more lease-purchases. For example, in some embodiments, while operating in the associate mode, the lease-purchase system and method can enable a sales associate to review the lease-purchase progress of one or more customers. FIG. 20 illustrates a customer progress display screen 2000 of the lease-purchase system and method in accordance with some embodiments of the invention. In some embodiments, the lease-purchase information can be displayed as a function of the activity or name of the customer using selection icons 2025. Customer progress information (shown in the display 2005) can comprise pending delivery date 2030, pending order confirmation 2040, in progress status 2050, and/or complete status of any customer (shown as 2060). In some embodiments, the lease-purchase information can include pending order confirmation 2040 that comprises order information, agreement status, delivery status, application approval information, payment information, and store invoice information.

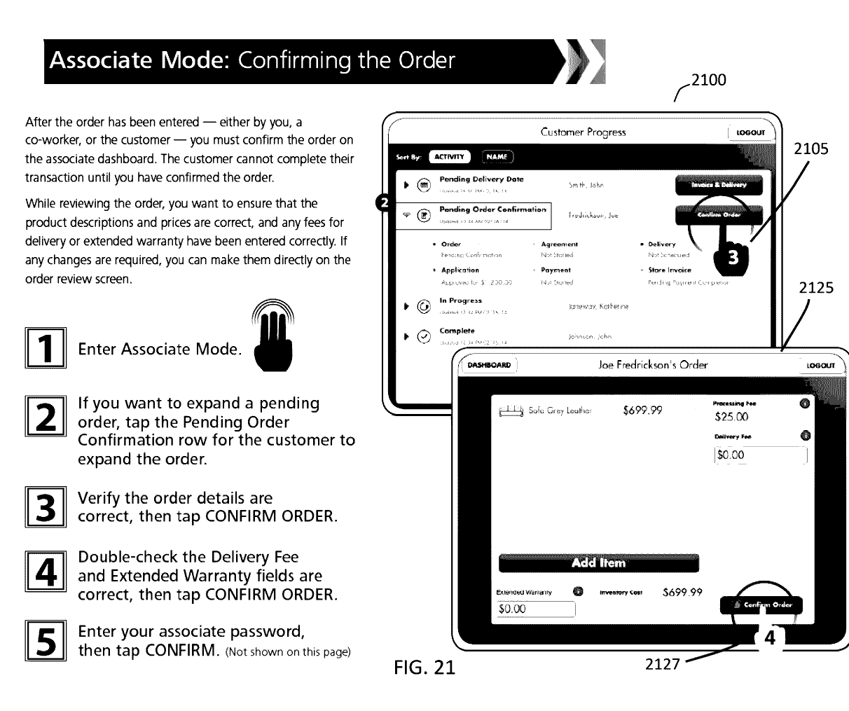

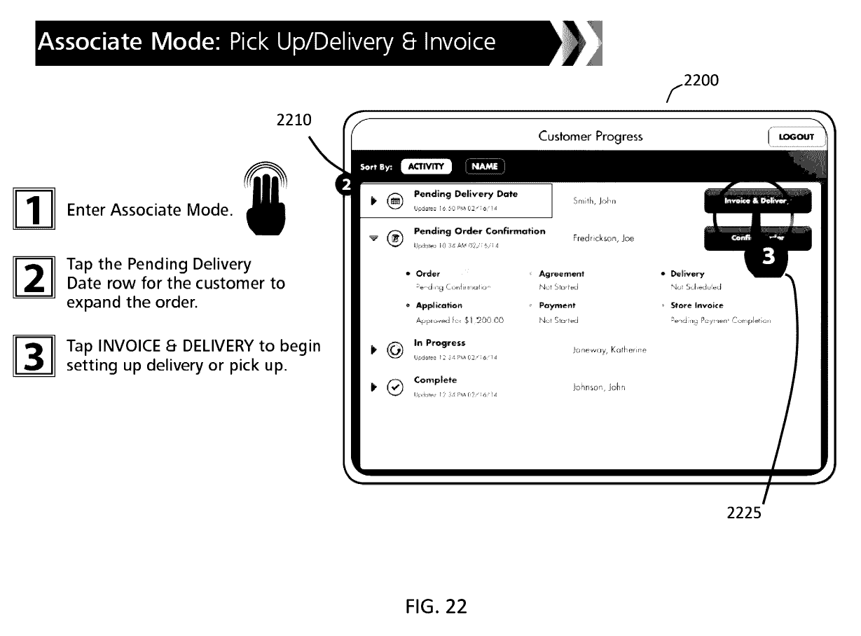

Some embodiments of the lease-purchase system and method can enable a sales associate to review and confirm invoice and delivery (icon 2070) and/or review and confirm a lease-purchase order (icon 2075, and discussed in relation to FIG. 22). After an order has been entered into the lease-purchase system and method (either by a customer or a sales associate) the lease-purchase order can be confirmed by a sales associate while in the associate mode of the lease-purchase system and method. This process is illustrated in FIG. 21, depicting an associate mode order confirmation of the lease-purchase system and method in accordance with some embodiments of the invention. As shown, after a sales associate enters the associate mode, the sales associate can expand a pending order by tapping the pending order confirmation row for the customer to expand the order (display screen 2100 with selection action 2105). The sales associate can verify order details, and can then confirm the order (e.g., by tapping the “confirm order” icon using selection action 2015). Further, the sales associate can review the delivery fee and/or the extended warranty fields, and can tap to confirm the order as previously described. In some embodiments, the sales associate can enter the associate password and tap to confirm to confirm at least a portion of the order (shown as selection action 2127 in display screen 2125 of FIG. 21).

In some embodiments of the invention, the associate mode can enable a user such as a sales associate to set up delivery or pick up of one or more products of one or more lease-purchase orders. For example, FIG. 22 illustrates an associate mode pick up/delivery and invoice entry display screen 2200 of the lease-purchase system and method in accordance with some embodiments of the invention. In some embodiments, a sales associate can enter the associate mode and tap the “pending delivery date” row for a customer to expand the order (see 2210). The sales associate can then tap “invoice and delivery” to begin setting up delivery and pick up of one or more products (selection action 2225).

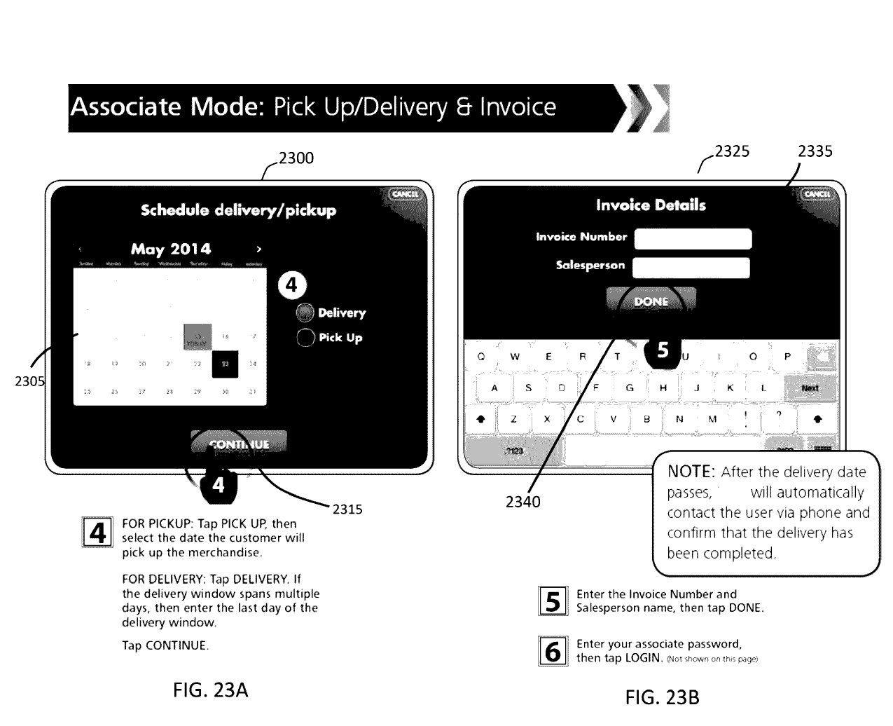

FIGS. 23A and 23B illustrate an associate mode pick up/delivery and invoice process of the lease-purchase system and method in accordance with some embodiments of the invention. As shown in FIG. 23A, in some embodiments, the lease-purchase system and method can display a calendar 2305 to enable a sales associate to select a delivery and/or pick up date, and the sales associate can proceed to enter invoice details following selection action 2315. As shown in FIG. 23B, invoice details can be entered by the sales associate using the invoice number and salesperson fields (fields 2335) and selection action 2340. In some embodiments, after the delivery date passes, the lease-purchase system and method can prompt contact with the user via telephone and confirm that the delivery has been completed.

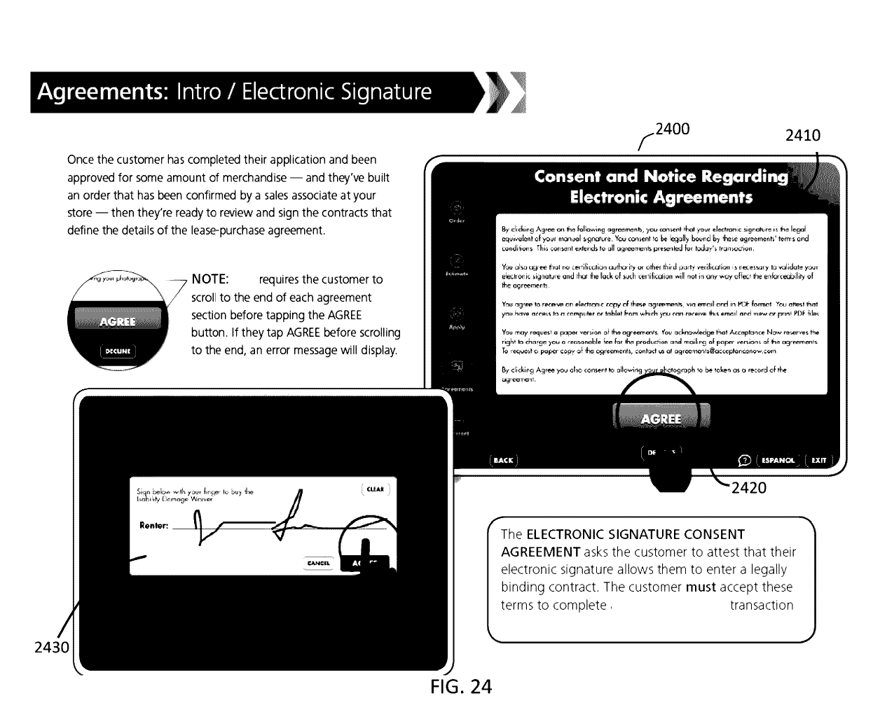

In some embodiments of the invention, the lease-purchase system and method can enable a customer to electronically sign a completed and approved lease-purchase application. The lease-purchase system and method can display a consent and notice regarding electronic agreement, and enable a customer to review and agree to the electronic signature consent and agreement. For example, FIG. 24 illustrates an electronic signature display screen 2400 of the lease-purchase system and method in accordance with some embodiments of the invention. The lease-purchase system and method can display the consent and notice 2410, and enable the user to scroll the consent and notice 2410, and agree to the consent and notice using an agree icon 2420. In some embodiments, if the customer taps the agree icon 2420 without reviewing (by scrolling) the entire notice, an error message can be displayed. Further, the lease-purchase agreement can be displayed to the customer for review and acceptance or declination. Once the customer has completed the application, been approved for some amount of merchandise, and built an order that has been confirmed by a sales associate, the customer can review and sign one or more contracts that define the details of the lease-purchase agreement. In some embodiments, an electronic signature 2430 can be entered by the customer to complete the agreement.

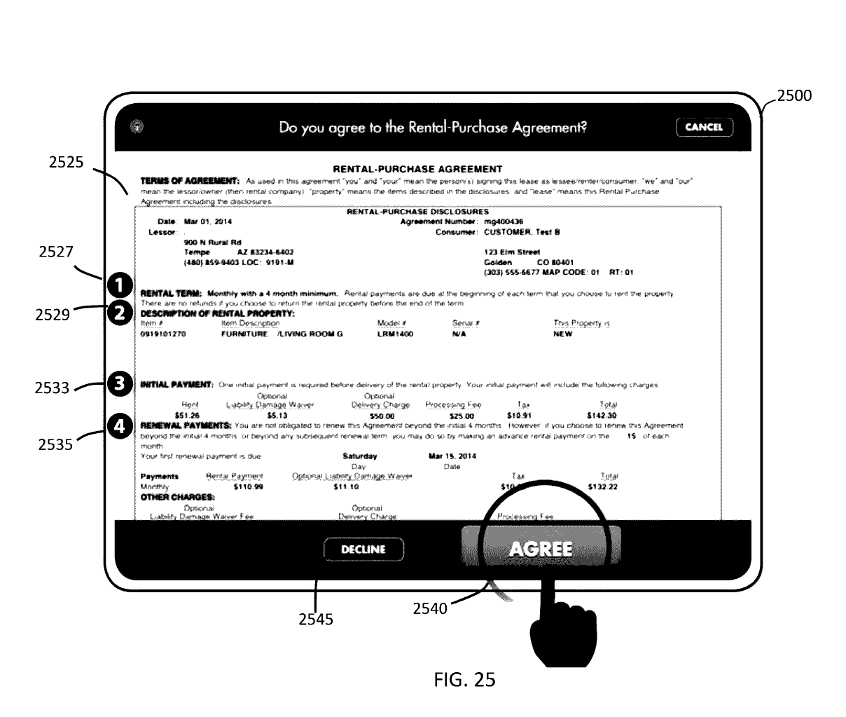

Referring to FIG. 25, illustrating a rental purchase agreement display screen 2500 of the lease-purchase system and method, in some embodiments, the display screen can include an example rental agreement 2525 that can include the rental term 2527, a description of the rental property 2529, the initial payment 2533, and the renewal payments 2535. If the customer finds the lease-purchase agreement acceptable, the customer can accept the agreement by tapping the “agree” icon (2540). If the customer does not find the lease-purchase agreement acceptable, the customer can decline the agreement by tapping the “decline” icon (2545).

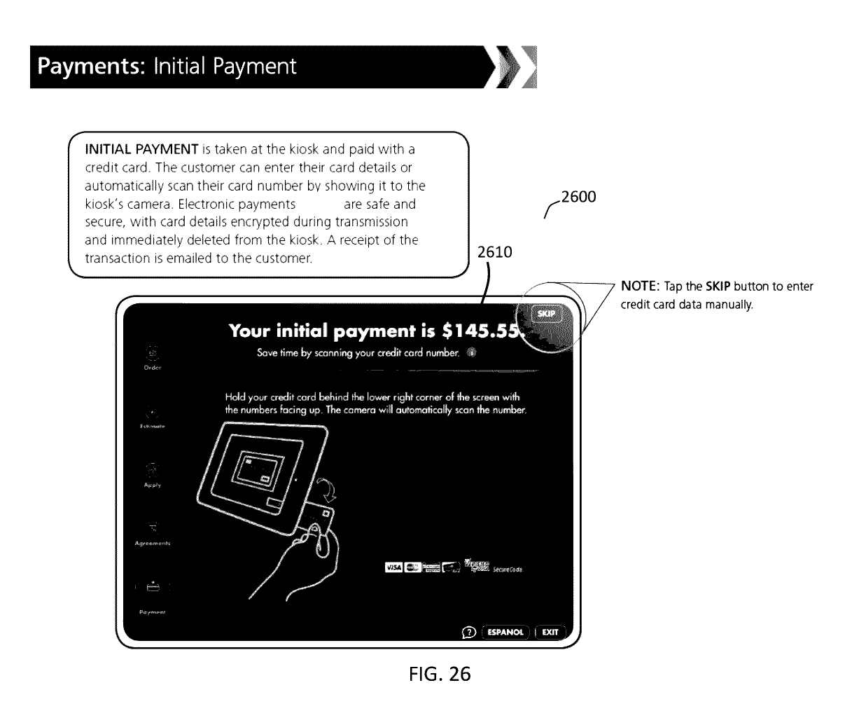

Some embodiments of the invention enable a customer to pay for at least a portion of the lease-purchase of one or more products using a kiosk-type payment method. In some embodiments, lease-purchase system and method can display an initial payment process display screen using a dedicated lease-purchase system and method kiosk. A kiosk, such as the previously described touch-screen type kiosk, can be used to provide an initial payment or subsequent payments. For example, FIG. 26 illustrates an initial payment process display screen 2600 of the lease-purchase system and method in accordance with some embodiments of the invention. In some embodiments, an initial payment can be taken at the kiosk and paid with a payment card such as a credit or debit card. In some embodiments, the customer can enter their credit card details or automatically scan their card number using a camera coupled to the kiosk. In some embodiments, electronic payments can include encrypted credit card information during payment transmission. Further, the payments and payment information can be immediately deleted from the kiosk after the transmission is complete. In some embodiments, a receipt of the transaction can be emailed to the customer. As illustrated in FIG. 26, the display screen 2600 can include the initial payment amount (2610). As illustrated, the lease-purchase system and method can also display instructions for making a payment and/or information related to accepted finance companies, banks, credit card companies, etc.

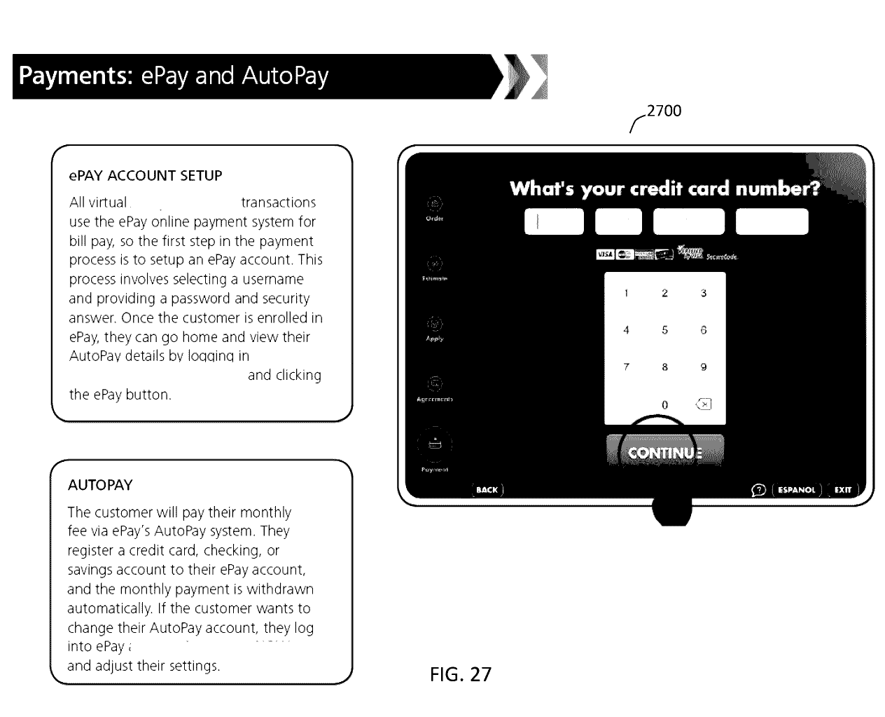

In some embodiments, credit/debit card payments from the customer can be made directly through the lease-purchase system and method. In some further embodiments, the lease-purchase system and method can use an online payment solution including an electronic funds transfer (“EFT”) or automated clearing house (“ACH”) payments authorization through an online payment solution. For example, FIG. 27 illustrates a payments ePay and AutoPay display screen 2700 of the lease-purchase system and method in accordance with some embodiments of the invention. In some embodiments, a customer can pay for one or more monthly payments or an upfront payment using an online payment solution, including, but not limited to ePay, Autopay, PayPal®, Apple Pay™, Google Wallet™, Amazon Payments, Skrill payments, and any other online payment solution. In this instance, the user can establish an ePay account to process the payment using a registered credit card, checking, or savings account. This process can involve selecting a username and providing a password and security answer. Once the customer is enrolled in ePay, they can view their Autopay details by logging into the lease-purchase system and method, and clicking the ePay button (icon). In some embodiments, AutoPay enrollment can be configured within an associate mode. Google Wallet™ is a registered trademark of Google. Apple Pay™ is a registered trademark of Apple Inc. PayPal® is a registered trademark of PayPal, Inc.

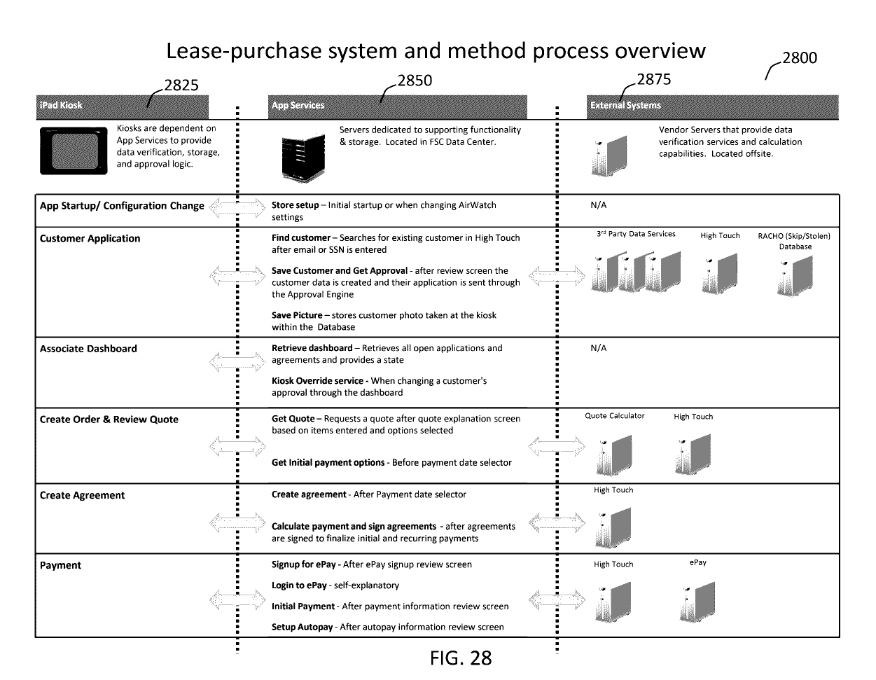

FIG. 28 illustrates a lease-purchase process overview of the lease-purchase system and method in accordance with some embodiments of the invention. In some embodiments, the lease-purchase system and method can be operated and accessed through touch-screen kiosk type GUI coupled to one or more external computer systems. In some embodiments of the invention, the lease-purchase system and method can operate through a kiosk on a computer tablet (e.g., such as a touch screen type kiosk as described earlier) that can function as a primary interface to the user (shown as kiosk 2825). In some embodiments, by coupling to at least one other computer system, the lease-purchase system and method perform a variety of functional, administrative, and operational tasks, including, but not limited to performing an application startup and/or configuration change, processing a customer application, operating an associate dashboard, preparing a create order & review quote, preparing a create agreement, and processing a payment. Any function or task processed through the kiosk can couple to one or more application services (2850) by using at least one computer system comprising at least one server dedicated to supporting lease-purchase system and method functionality & storage. Further, in some embodiments, the kiosk 2825 coupled to one or more application services 2850 can be configured to exchange information with one or more external or third party systems (shown as 2875). In some embodiments, these systems can provide data and/or process data to support one or more functions or requests by the lease-purchase system and method. For example, in some embodiments, the lease-purchase system and method can be coupled to one or more external computer systems, such as third party servers that provide data verification services and calculation capabilities for the lease-purchase system and method.

In some embodiments, the kiosk (2825), when processing an application startup and/or configuration change, can utilize lease-purchase system and method application services to store setup parameters. In some embodiments, this can occur during initial startup or when changing remote security and application management solution (e.g., AirWatch) settings.

In some embodiments, the kiosk 2825 processing a customer application can couple to lease-purchase system and method application services 2850 to perform a find customer function. In this instance, the lease-purchase system and method application services can search for an existing customer in the customer transaction records maintained and/or referenced by the point of sale system. In some embodiments, this can occur after an email or Social Security number is entered by the user. Further, in some embodiments, the kiosk 2825 processing a customer application can couple to lease-purchase system and method application services 2850 to perform a “Save Customer and Get Approval” function. In some embodiments, after display of a review screen, customer data is created and the lease order/application is processed through at least one approval engine. In some further embodiments, the kiosk 2825 processing a customer application can couple to lease-purchase system and method application services 2850 to perform a “Save Picture” function. In this instance, the lease-purchase system and method application services can store one or more customer photographs taken at the kiosk within the lease-purchase system and method database.

In some embodiments, the kiosk 2825 operating within an associate mode (e.g., displaying an associate dashboard) can couple to lease-purchase system and method application services 2850 to perform a “retrieve dashboard” function. In some embodiments, the lease-purchase system and method application services 2850 can retrieve all open applications and agreements and provide a status update to the user. For example, in some embodiments, any agreements (either in process, signed and current, or expired) can be retrieved and viewed by the user (e.g., such as an associate). In some embodiments, the associate dashboard can include a re-launch kiosk button configured to enable any kiosk 2825 to be re-started and/or to be re-launched. Some embodiments of the invention include an associate dashboard that includes a store info call function and/or a demo checkbox. In some further embodiments of the invention, the kiosk 2825 can be configured to display a training library directory and content views.

In some embodiments, the lease-purchase system and method application services can provide a “kiosk override service” when changing a customer's approval through the dashboard. In some embodiments, a customer's approval amount can be overridden within the associate mode. In some embodiments, the customer's approval amount can be overridden by changing an automated approval amount through the kiosk 2825 operating within an associate mode. For example, in some embodiments, following an automated approval, a customer's approval amount can be manually increased. In some embodiments, the customer's approval amount can be manually increased with additional verification in order to close a sale. In some further embodiments, the lease-purchase system and method can request or require additional information during an associate review process in order to manually approve a customer that was otherwise disqualified during verification (e.g., flagged as skip/stolen in the point of sale customer records).

In some embodiments, the lease-purchase system and method application services 2850 can perform “Create order and review quote” functions. For example, in some embodiments, the lease-purchase system and method application services 2850 can perform a “Get Quote” service where the user requests a quote after display of a quote explanation screen based on items entered and options selected. Further, the lease-purchase system and method application services 2850 can provide “Get Initial payment options” to enable a user to review and select initial payment options using a before payment date selector. In some embodiments, one or more external (third party) computer systems 2875 can be used to access customer databases and/or to provide quotations.

In some embodiments, the lease-purchase system and method application services 2850 can perform “Create agreement” functions. For example, in some embodiments, a “Create agreement” function can be provided using an after payment date selector. Further, in some embodiments, the lease-purchase system and method application services 2850 in conjunction with one or more external (third party) computer systems 2875 can be used to perform “calculate payment and sign agreements” functions; for example, in some embodiments, after agreements are signed, to finalize initial and recurring payments.

In some embodiments, the lease-purchase system and method application services 2850 in conjunction with one or more external (third party) computer systems 2875 can be used for “Payment functions”. For example, in some embodiments, the lease-purchase system and method application services 2850 can perform a “Signup for ePay” function (e.g., after display of the ePay signup review screen). Other functions can include “Login to ePay”, “Initial Payment”, after payment information review screen, “Setup Autopay”, after autopay information review screen.

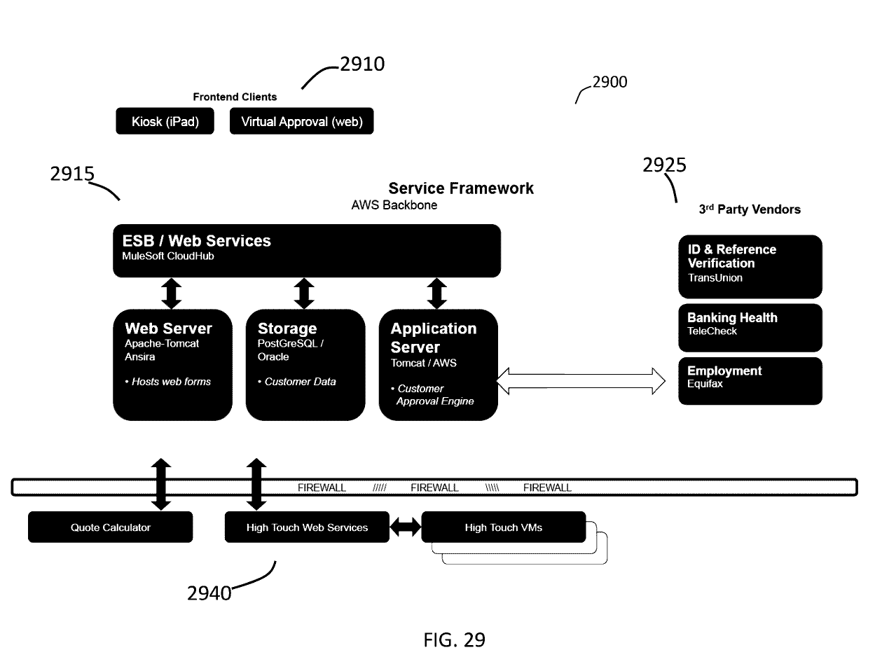

The organization and data flow between the lease-purchase system and method application services and external (third party) computer systems and the kiosk can be further visualized in FIG. 29, illustrating a system framework 2900 of the lease-purchase system and method in accordance with some embodiments of the invention. In some embodiments, using one or more front end clients 2910, the lease-purchase system and method can couple to a lease-purchase system and method backbone 2915 configured to process one or more lease-purchase system and method application services. As shown, the backbone 2915 can comprise web services operating with a web server, storage devices, and an application server. The web server can host web forms, the application server can host a customer approval engine, and storage can comprise customer data. Moreover, the backbone can couple to a plurality of external systems configured to provide data or services to the lease-purchase system and method. For example, in some embodiments, the lease-purchase system and method application services, can couple through the backbone to one or more external computer systems 2925 providing identification and reference information, financial status (such as banking health), and employment information. Further, in some embodiments, the backbone can couple to a plurality of external systems 2940 configured to provide processing services including a quote calculator, point-of-sale system, web and VMS services.

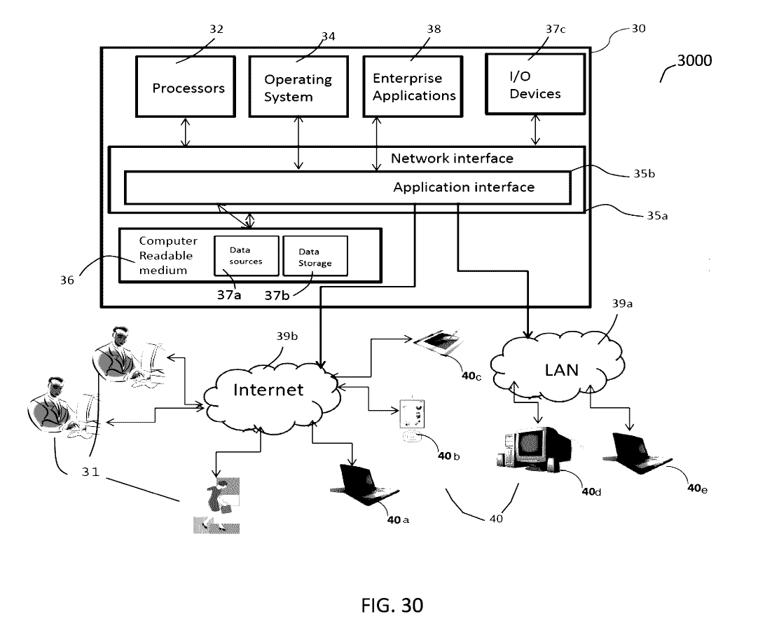

FIG. 30 illustrates a computer system 30 configured for operating and processing components of the lease-purchase system and method in accordance with some embodiments of the invention. In some embodiments, the computer system 30 can process one or more software modules of the aforementioned lease-purchase system and method applications (FIG. 28) and display information related to lease purchase transactions within a graphical user interface using a front end such as the aforementioned kiosk. Further, in some embodiments, the system framework of the lease-purchase system and method shown in FIG. 29 can use the computer system 30 to process one or more lease-purchase system and method application services. The system framework can also manage the organization of data and data flow between the lease-purchase system and method application services, the front end systems, and external (third party) computer systems.

As shown, the system 30 can include at least one computing device, including one or more processors 32. Some processors 32 can include processors 32 residing in one or more conventional server platforms. The system 30 can include a network interface 35a and an application interface 35b coupled to at least one processor 32 capable of running at least one operating system 34. Further, the system 30 can include a network interface 35a and an application interface 35b coupled to at least one processors 32 capable of running one or more of the software modules (e.g., enterprise applications 38). The software modules 38 can include server-based software platform that can include lease-purchase software modules suitable for hosting at least one user account and at least one client account, as well as transferring data between one or more accounts.

With the above embodiments in mind, it should be understood that the invention can employ various computer-implemented operations involving lease-purchase data stored in computer systems. Moreover, the above-described databases and models throughout the lease-purchase can store analytical models and other data on computer-readable storage media within the system 30 and on computer-readable storage media coupled to the system 30. In addition, the above-described applications of the lease-purchase system can be stored on computer-readable storage media within the system 30 and on computer-readable storage media coupled to the system 30. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

Some embodiments include the system 30 comprising at least one computer readable medium 36 coupled to at least one data storage device 37b, and/or at least one data source 37a, and/or at least one input/output device 37c. In some embodiments, the invention embodied by the lease-purchase system can also be embodied as computer readable code on a computer readable medium 36. The computer readable medium 36 can be any data storage device that can store data, which can thereafter be read by a computer system (such as the system 30). Examples of the computer readable medium 36 can include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor (including processors 32).

In some embodiments of the invention, the computer readable medium 36 can also be distributed over a conventional computer network via the network interface 35a so that the lease-purchase system embodied by the computer readable code can be stored and executed in a distributed fashion. For example, in some embodiments, one or more components of the system 30 can be tethered to send and/or receive data through a local area network (“LAN”) 39a. In some further embodiments, one or more components of the system 30 can be tethered to send or receive data through an internet 39b (e.g., a wireless internet). In some embodiments, at least one software application 38 running on one or more processors 32 can be configured to be coupled for communication over a network 39a, 39b. In some embodiments, one or more components of the network 39a, 39b can include one or more resources for data storage, including any other form of computer readable media beyond the media 36 for storing information and including any form of computer readable media for communicating information from one electronic device to another electronic device.

In some embodiments, the network 39a, 39b can include wide area networks (“WAN”), direct connections (e.g., through a universal serial bus port) or other forms of computer-readable media 36, or any combination thereof. Further, in some embodiments, one or more components of the network 39a, 39b can include a number of client devices which can be personal computers 40 including for example desktop computers 40d, laptop computers 40a, 40e, digital assistants and/or personal digital assistants (shown as 40c), cellular phones or mobile phones or smart phones (shown as 40b), pagers, digital tablets, internet appliances, and other processor-based devices. In general, a client device can be any type of external or internal devices such as a mouse, a CD-ROM, DVD, a keyboard, a display, or other input or output devices 37c. In some embodiments, various other forms of computer-readable media 36 can transmit or carry instructions to a computer 40, including a router, private or public network, or other transmission device or channel, both wired and wireless. The software modules 38 can be configured to send and receive data from a database (e.g., from a computer readable medium 36 including data sources 37a and data storage 37b that can comprise a database), and data can be received by the software modules 38 from at least one other source. In some embodiments, at least one of the software modules 38 can be configured within the system to output data to at least one user 31 via at least one digital display (e.g., to a computer 40 comprising a digital display). In some embodiments, the user 31 can comprise a customer or a sales associate.

In some embodiments, the system 30 as described can enable one or more users 31 to receive, analyze, input, modify, create and send data to and from the system 30, including to and from one or more enterprise applications 38 running on the system 30. Some embodiments include at least one user 31 coupled to a computer 40 accessing one or more modules of the lease-purchase system including at least one enterprise application 38 via a stationary I/O device 37c through a LAN 39a. In some other embodiments, the system 30 can enable at least one user 31 (through computer 40) accessing enterprise applications 38 via a stationary or mobile I/O device 37c through an internet 39a.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

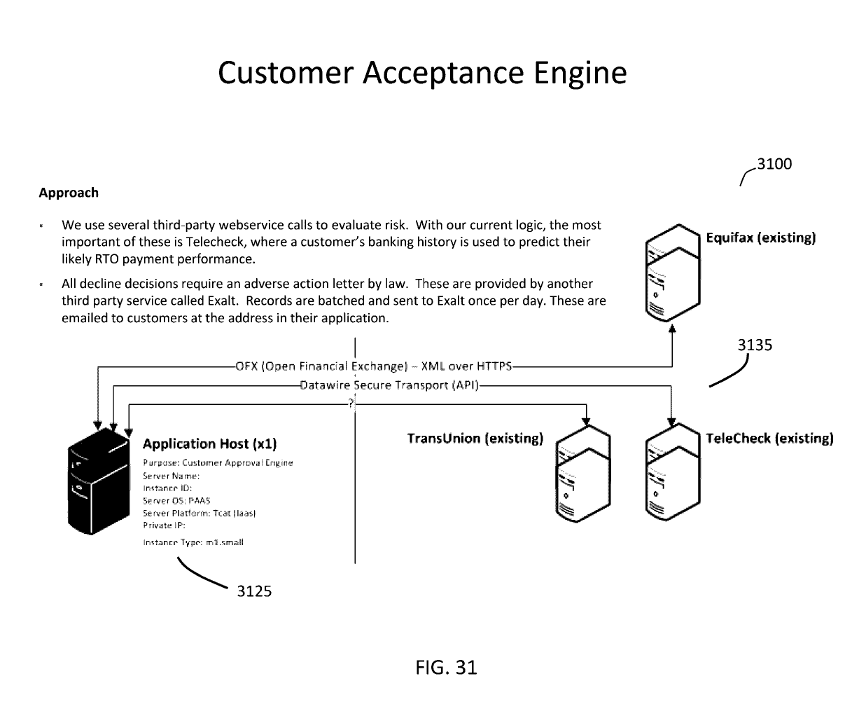

Some embodiments of the invention include a lease-purchase system and method that comprises a customer acceptance engine configured to assist with the customer approval process. Using this component, the lease-purchase system and method can provide an automated method to approve customers with less data and without a credit check. In some embodiments, the customer approval engine can provide a risk evaluation that does not require any human interaction. For example, in some embodiments, in some embodiments, the customer acceptance engine can use one or more third-party webservice calls to evaluate risk without reference to a FICO score. FIG. 31 illustrates an overview 3100 of the customer acceptance engine of the lease-purchase system and method in accordance with some embodiments of the invention. In some embodiments, the application host 3125 can process the customer approval engine to evaluate risk without reference to a FICO score. In some embodiments, the application host 3125 can access one or more third party databases (shown as 3135) (e.g., using webservice calls). In some embodiments, the customer's banking history can be used to predict their likely lease-purchase payment performance. In some embodiments, the lease-purchase system and method can use one or more third party services to assess the customer's banking history. For example, in some embodiments, the lease-purchase system and method can use Telecheck® to perform a banking analysis. Moreover, in some embodiments, TransUnion LLC or other similar company's services can be used to check financial information related to the customer without reference to a FICO score. In some further embodiments, the lease-purchase system and method can deploy third-party services to decline decisions that require an adverse action letter by law. For example, in some embodiments, decline decisions can be provided by a third party service such as Exalt. In this example, records can be batched and sent to Exalt once per day. These are emailed to customers at the address in their application.

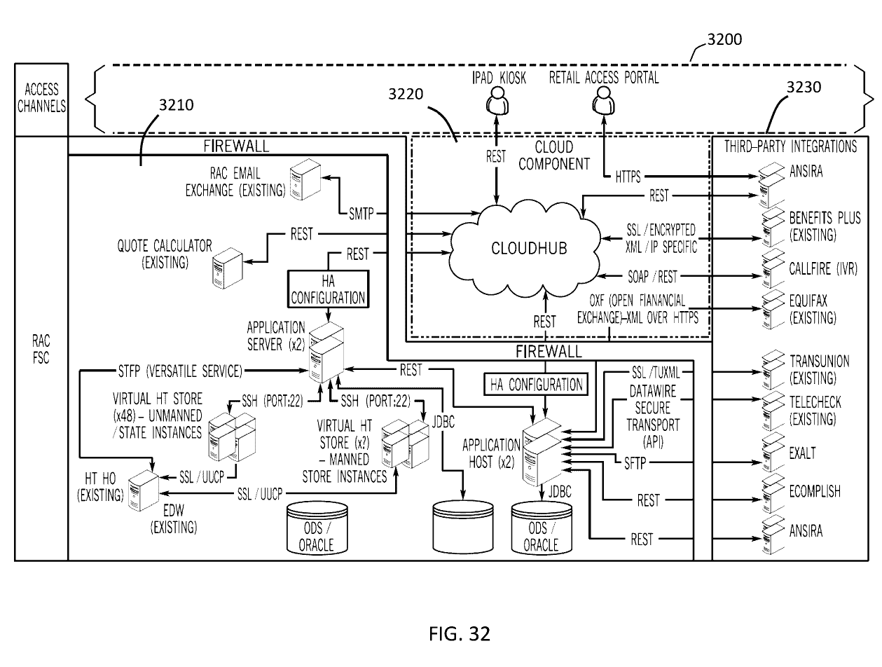

FIG. 32 illustrates a lease-purchase system and method detailed system architecture in accordance with some embodiments of the invention. In some embodiments, the lease-purchase system and method can be operated using one or more computer systems (e.g., such as the previously described computer system 30) structured as shown in the system architecture FIG. 32. In some embodiments, various server and database components of the lease-purchase system and method (shown as 3210) can operated within at least one firewall, and can selectively communicate and exchange data through the firewall to customers or associates. In some embodiments, the communication can occur through at least one kiosk and/or at least one retail access portal through a cloud component (shown as 3220). Moreover, in some embodiments, a plurality of third party systems (shown as 3230) can be coupled to the system architecture, coupled through the cloud component and/or through the firewall to one or more servers and database components of the lease-purchase system and method.

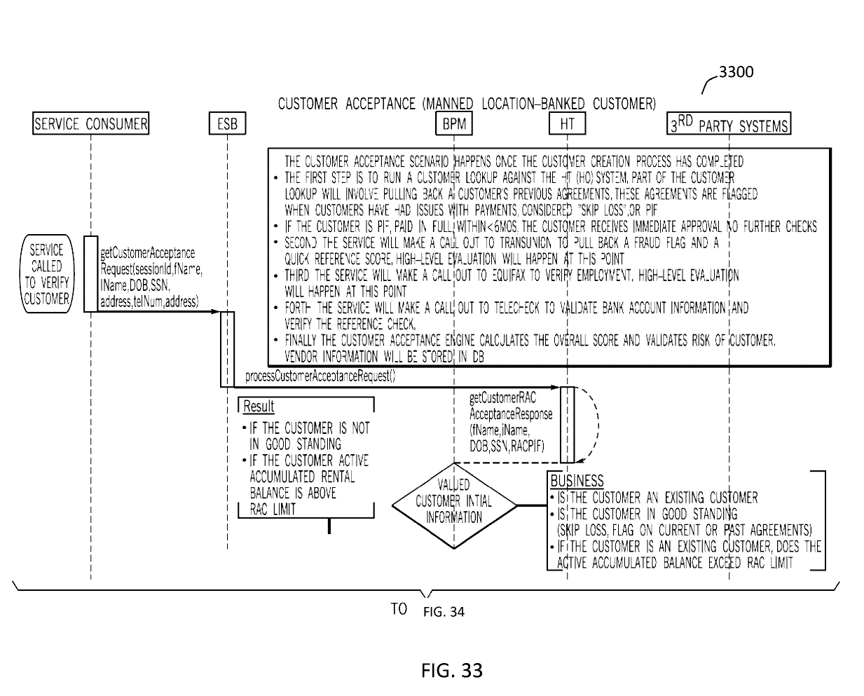

FIGS. 33-35 illustrate a lease-purchase system and method customer acceptance sequence diagram in accordance with some embodiments of the invention. In some embodiments of the invention, once the customer creation process has been completed, the lease-purchase system and method can process at least a portion of the customer acceptance sequence outlined in FIGS. 33-35 (illustrating portions 3300, 3400, 3500 of the customer acceptance sequence diagram). Referring to FIG. 33, in some embodiments, the lease-purchase system and method can perform a customer lookup using one or more customer databases. For example, in some embodiments a customer lookup can be run against point-of-sale system data. In some embodiments, a component of this process can involve accessing the customer's previous agreements. These agreements can be flagged when customers have had issues with payments including being considered “skip loss” or when the customer's performance has been positive and the account has been paid in full (“PIF”). In some embodiments of the invention, if the customer is “PIF” within less than six months, the customer can receive an immediate approval and no further checks will be performed.

In some embodiments of the invention, the lease-purchase system and method can access information and/or exchange customer related data with one or more third parties such as Equifax, Inc., (hereinafter “Equifax”), TransUnion, LLC., (hereinafter “TransUnion”), and/or Telecheck Services Inc., (hereinafter “Telecheck”), etc. In some embodiments of the invention, the lease-purchase system and method can make a call to one or more third parties to assess fraud. For example, in some embodiments of the invention, the lease-purchase system and method can make a call to TransUnion to pull a fraud flag. Further, a quick reference score quantifying the fraud risk identified by the fraud flag can be assigned by TransUnion, and a high level evaluation can be processed by the lease-purchase system and method at this point. Further, the service can make a call out to Equifax to verify employment, and a high level evaluation can occur. The lease-purchase system and method can then make a call to Telecheck to validate bank account information, and verify the reference check. Finally, the lease-purchase system and method (the customer acceptance engine) can calculate an overall risk assessment score without reference to a FICO score.

Referring to FIG. 33 showing sequence portion 3300, proceeding with the service to the consumer, the service can be called to verify a customer. In some embodiments, the lease-purchase system and method can determine if the customer is not in good standing and/or if the customer's active accumulated rental balance is above a specified limit. Further, the lease-purchase system and method can make a determination of initial information regarding a valued customer. For example, is the customer an existing customer? Is the customer in good standing (assessing skip loss, or a flag on current or past agreements exists)? Further, if the customer is an existing customer, the lease-purchase system and method can determine if the active accumulated balance exceeds a specified limit. As described earlier, in some embodiments, the lease-purchase system and method can request or require additional information during an associate review process in order to manually approve a customer that was flagged as skip/stolen. Further, in some embodiments, if an approval engine returns a result requiring associate review in an unmanned location (e.g., such as at an unmanned kiosk), a decline response can be returned to the customer or other user.

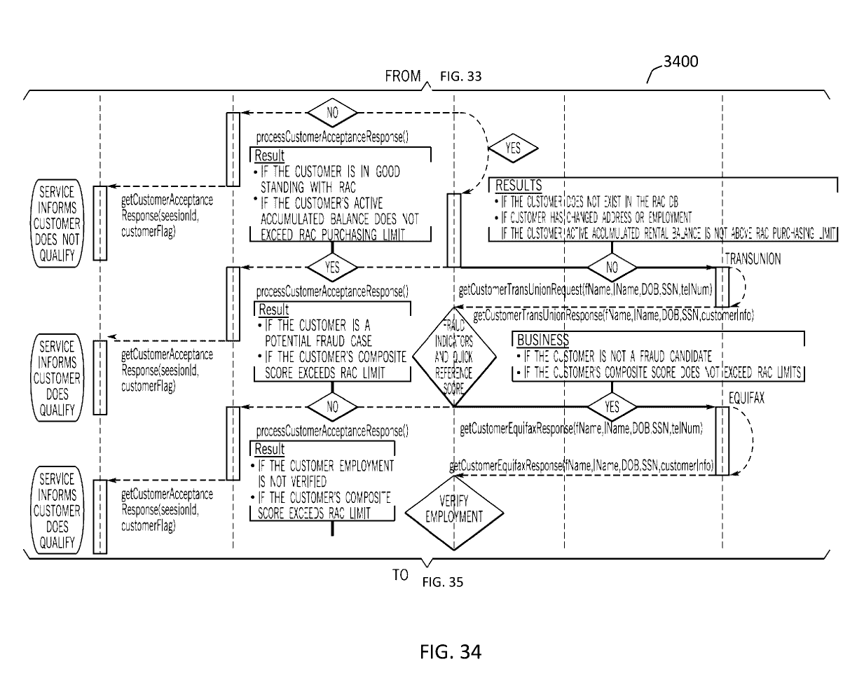

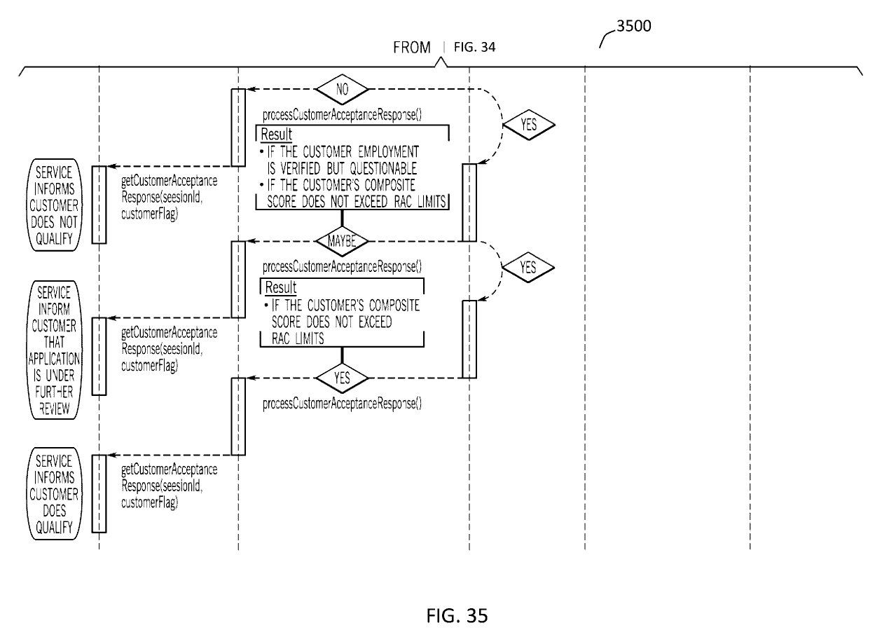

Referring to FIG. 34 showing sequence portion 3400, in some embodiments, if the customer is not in good standing, or if the customer's active accumulated rental balance exceeds a specified limit, the lease-purchase system and method can inform the customer that he or she does not qualify. In some embodiments, if the customer is in good standing with the lease-purchase system and method, and the customer's accumulated balance does not exceed a specified purchasing limit, the lease-purchase system and method can inform the customer that he or she qualifies.

In some further embodiments, the lease-purchase system and method can perform an assessment of whether the customer is presents an unacceptable risk of fraud (a “fraud candidate”). In some embodiments, once the lease-purchase system and method determines the customer is not a fraud candidate and the customer's composite score does not exceed specified limits, employment verification can be performed. If the customer is not a fraud candidate, and the customer's composite score is not exceeded, the lease-purchase system and method can inform the customer that he or she qualifies.

Referring to FIG. 35, showing sequence portion 3500, if the customer employment is not verified and/or if the customer's composite score is above a specified limit, the lease-purchase system and method can inform the customer he or she does not qualify. Conversely, if the answers are positive, the lease-purchase system and method can determine is the customer employment is verified but questionable and/or if the customer's composite score does not exceed a specified limit. If the answer is maybe or possible, the lease-purchase system and method can inform the customer that the application is under further review. If the answers are true, the lease-purchase system and method can determine if the customer's composite score does not exceed specified limits. If the answer is yes, then some embodiments of the lease-purchase system and method can inform the customer that they do qualify.

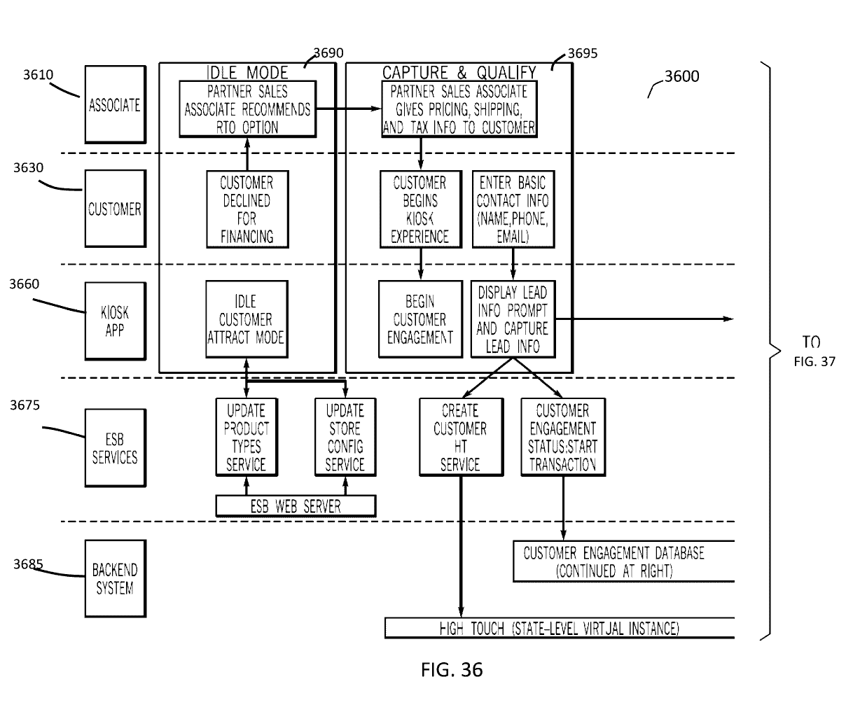

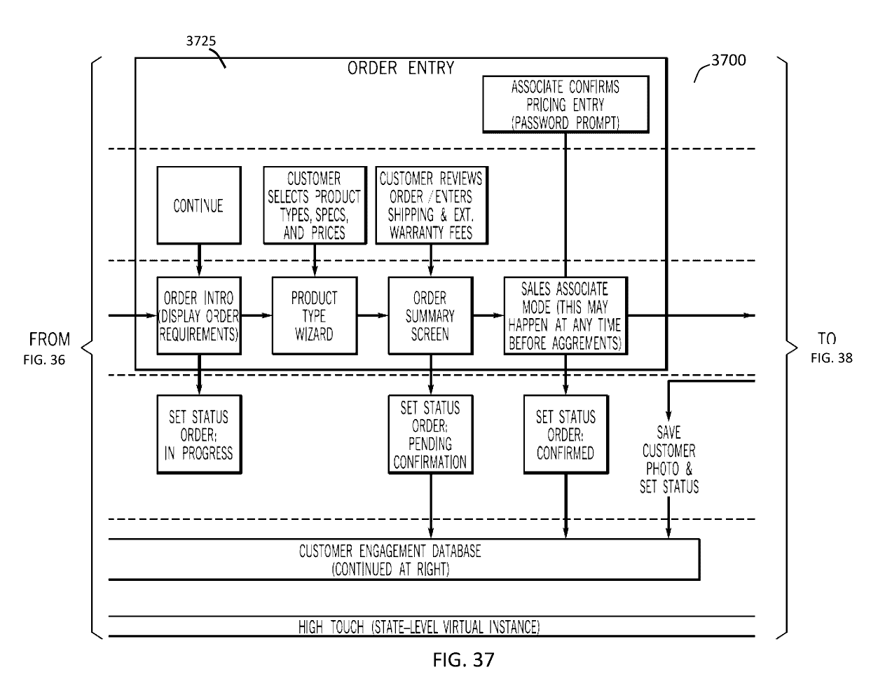

The lease-purchase system and method process flow diagram illustrated within FIGS. 36-43 provide details of the operation of the lease-purchase system and method. Some user interactions, actions, and/or operations are shown as associate mode operations (3610) and customer mode operations (3630). Front end operations are shown as “Kiosk APP” (3660) and can be functionally coupled to lease-purchase system and method application services shown as enterprise bus service (“ESB services”) (3675), both of which can be coupled to one or more backend services shown as “Backend system” (3685). Further, the various operations and functions as described can occur within various phases of the operation of the lease-purchase system. These phases include “idle mode” (3690), “capture and qualify” (3695), “order entry” (3725), “estimate” (3825), “customer application” (3850), “agreement” (3925), “payment” (4025), “wrap up” (4125), “partner order processing” (4225), “partner invoicing” (4325), “delivery confirmation” (4350), and “account management” (4375).

Referring to FIG. 36, within the customer mode of the lease-purchase system and method, within the “idle mode” phase 3690, if a customer is declined for credit financing offered by or through the partner retailer, a partner sales associate can recommend a rent to own (“RTO”) option to the customer. Within the “capture and qualify” phase 3695, an associate operation can include the partner sale associate providing pricing, shipping and tax info to the customer. In some embodiments, the customer can begin a kiosk experience and can enter basic contact information including name, phone, and email address.

In some embodiments, using a “Kiosk APP” 3660, the customer can begin engagement with the lease-purchase system and method, and the lease-purchase system and method can display and capture lead information. Using “ESB services” 3675 coupled to the “Backend system” 3685, a customer record can be created in the customer transaction records maintained and/or referenced by the point of sale system, and a lease-purchase transaction can be initiated. Further, while in the “idle mode” phase 3690, the “Kiosk APP” 3660 can include an idle customer attract mode. “ESB services” 3675 can then update product type service and update store and configuration service from the “ESB” web server.

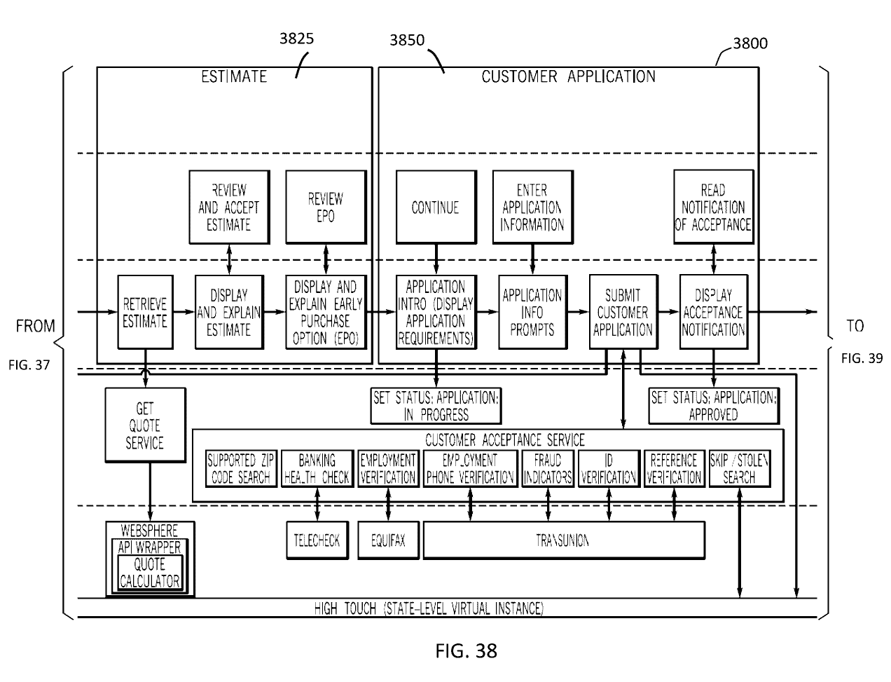

Referring to FIG. 37, some embodiments of the invention can include an “order entry” phase 3725 of the lease-purchase system and method. Within the “Kiosk APP” 3660, an order introduction can be displayed including order requirements, and “ESB services” 3675 can set status as order in progress. Using a product type wizard, the customer can select product types, specifications, and prices. Further, using the order summary screen, the customer can review orders, and can be prompted to enter shipping and extended warranty fees, and the “ESB services” 3675 can set status pending confirmation, coupling with customer engagement database in the “Backend system” 3685. Further, with the “Kiosk APP” 3660 in sales associate mode, a sales associate can confirm a pricing entry following a password prompt.

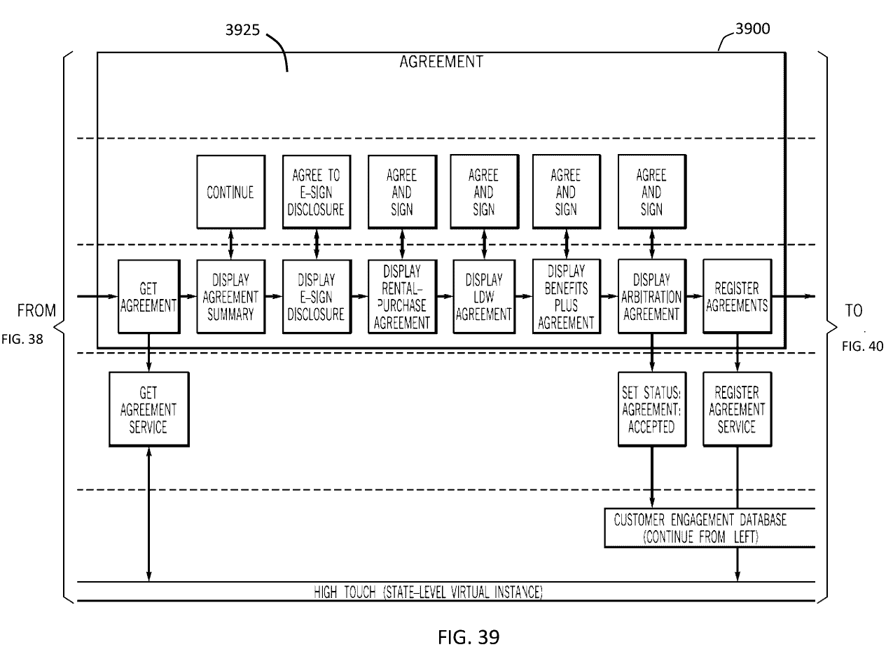

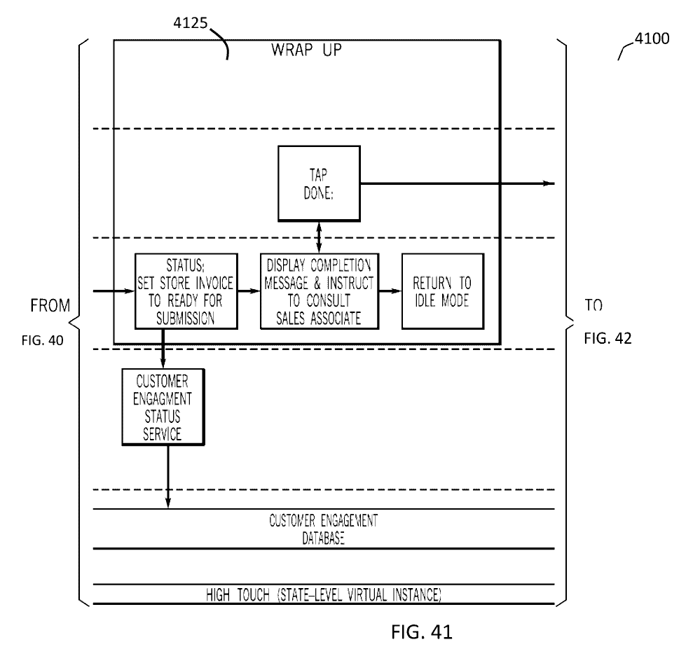

Referring to FIG. 38, during the “estimate” phase 3825, the lease-purchase system and method can retrieve an estimate by coupling from the “Kiosk APP” 3660 to get a quote service from a quote calculator running through an application interface within the websphere. After the customer reviews and accepts the estimate, the “Kiosk APP” 3660 can display and explain an EPO, providing an opportunity for the customer to review the EPO, and the lease-purchase system and method can enter a “customer application” phase 3850. The lease-purchase system and method can display a customer application introduction including application requirements and application information prompts. In some embodiments, after the customer has entered information, the customer application can be submitted through the “Kiosk APP” 3660, and the “ESB services” 3675 can save a customer photograph and set status (see FIG. 37). Further, using a customer service acceptance service within “ESB services” 3675, a risk analysis can be performed comprising “supported zip code search”, “banking health check”, “employment verification”, “employment phone verification”, “fraud indicators”, “ID verification” (by performing a verification of the customer's provided identification, for example through a kiosk), “reference verification”, and “skip/stolen search” (FIG. 40). As described earlier, some risk analysis can use external third party systems (that comprise the “Backend system” 3685) including Telecheck, Equifax, and TransUnion. Following an approval of the customer application, an acceptance notification can be displayed by the “Kiosk APP” 3660. The customer can review the notification of the acceptance, and the status can be set to application approved within the “ESB services” 3675. Further, in some embodiments of the invention, the lease-purchase system and method (such as a risk engine portion) can alert a user (e.g., such as a sales associate or employee of an entity providing the lease-purchase system and method) of the approval by automated telephonic messaging or electronic mail. In some embodiments, the phone call can contain an automated pronunciation of the approved customer's name and the approved amount.

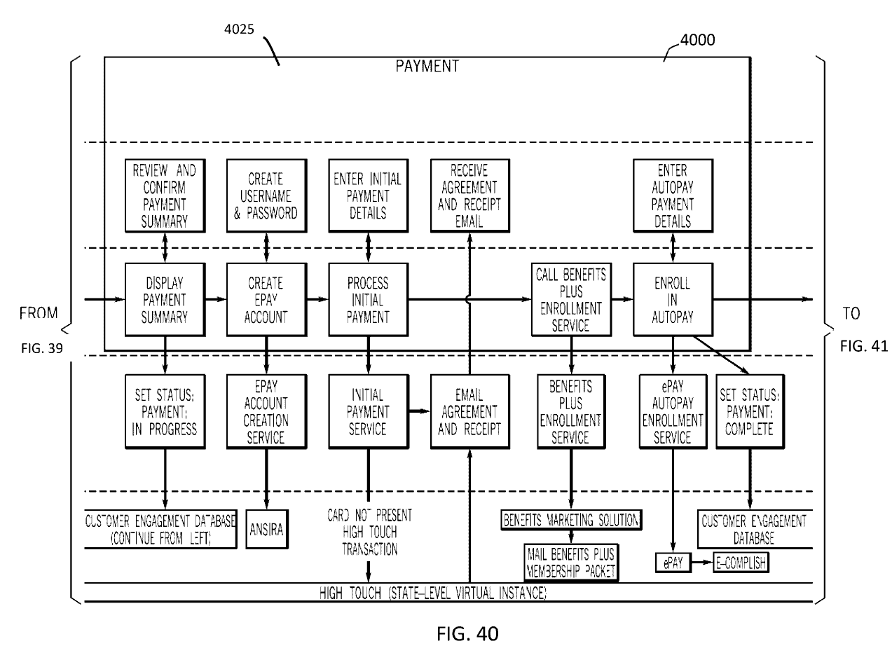

Referring to FIG. 39, in some embodiments, the lease-purchase system and method can include an “agreement” phase 3925. Following acceptance of the customer application, “Kiosk APP” 3660 can retrieve one or more agreements, couple to an agreement service within the “Backend system” 3685, and display an agreement summary. After the customer agrees to electronically sign one or more agreements, the “Kiosk APP” 3660 can display the e-sign disclosure, and the customer can agree and sign. The “Kiosk APP” 3660 can display at least one rental purchase agreement, and the customer can agree and sign at least one purchase agreement. Further, the “Kiosk APP” 3660 can display at least one “LDW” agreement, and the customer can agree and sign at least one “LDW” agreement. Subsequently, the “Kiosk APP” 3660 can display at least one “benefits plus” agreement, and the customer can agree and sign at least one agreement. Further, the “Kiosk APP” 3660 can display at least one arbitration agreement, and the customer can agree and sign at least one agreement. The “ESB services” 3675 can set the status as agreement accepted and update the customer engagement database for at least one agreement. In some embodiments, the “Kiosk APP” 3660 can register agreements through the “ESB services” 3675 and coupled to a point-of-sale or “Backend system” 3685 (i.e., third party service).

Referring to FIG. 40, in some embodiments, the lease-purchase system and method can include a “payment” phase 4025. After all agreements have been signed and registered, the “Kiosk APP” 3660 can display a payment summary, and the customer can review the payment summary. “ESB services” 3675 can set a status of payment in progress, and update the customer engagement database. The “Kiosk APP” 3660, through “ESB services” 3675 coupled “ANSIRA” in “backend systems” can create an ePay account using ePay account creation services. Further, the customer can input initial payment details, and the “Kiosk APP” 3660 can process an initial payment using an initial payment service in “ESB services” 3675, where “ESB services” 3675 can couple to a “Backend system” 3685 for a card not present point-of-sale transaction. From “ESB services” 3675, the initial payment service can email an agreement and receipt to customer.

Through “Kiosk APP” 3660, some embodiments of the lease-purchase system and method can call Benefits Plus enrollment service processed through the “ESB services” 3675, a Benefits Marketing Solutions enrollment can be processed using the “Backend system” 3685, and a Benefits Plus membership package can be mailed to the customer. Further, in some embodiments, the “Kiosk APP” 3660 can initiate an enrollment in “Autopay”, and the customer can enter autopayment details. In some embodiments of the invention, using “ESB services” 3675 coupled to “Backend system” 3685, the lease-purchase system and method can use an ePay/Autopay enrollment service coupling through the “Backend system” 3685 to ePay coupled to E-complish. Further, the “ESB services” 3675 can set payment status complete and update the customer engagement database.

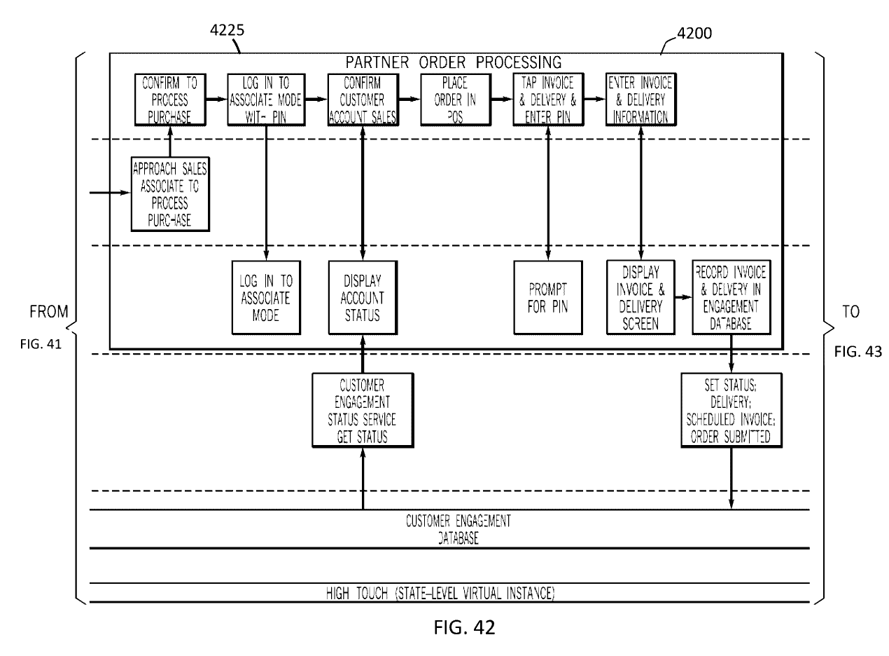

Referring to FIG. 41, in some embodiments, the lease-purchase system and method can include a “wrap up” phase 4125. After autopay enrollment is complete, the “Kiosk APP” 3660 can set store invoice to “ready for submission” by coupling to a “customer engagement status service” within the “ESB services” 3675 that is coupled to the customer engagement database of the “backend service”. In some embodiments, the “Kiosk APP” 3660 can display a completion message, can instruct the customer to consult with a sales associate, and can return to idle mode.

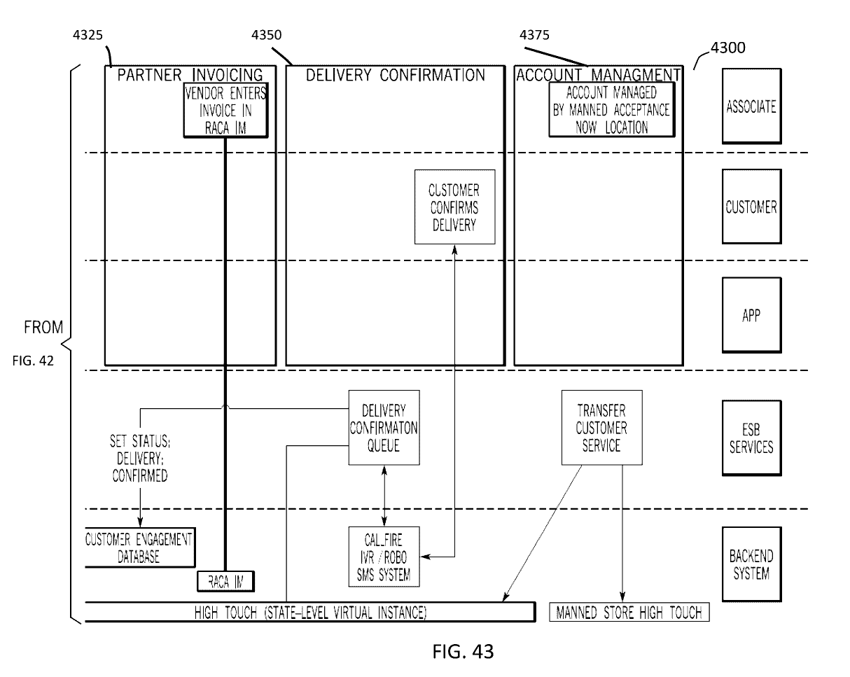

Referring to FIG. 42, in some embodiments, the lease-purchase system and method can include a “partner order processing” phase 4225. The customer can approach a sales associate to process the purchase. The sales associate can confirm to process the purchase, and through the “Kiosk APP” 3660, log into an associate mode using a PIN. The associate can confirm customer account sales, and the “Kiosk APP” 3660 can display an account status following receipt of information from “ESB services” 3675 customer engagement status service by coupling to the customer engagement database in “Backend system” 3685. Further, the associate can place the order in a point-of-sale system (“POS”), proceed with PIN entry, and enter invoice and delivery information. In some embodiments, the “Kiosk APP” 3660 can display an invoice and delivery screen and record invoice and delivery in an engagement database, with “ESB services” 3675 coupled to “Backend system” 3685 setting a status of delivery, scheduled invoice, and order submitted.

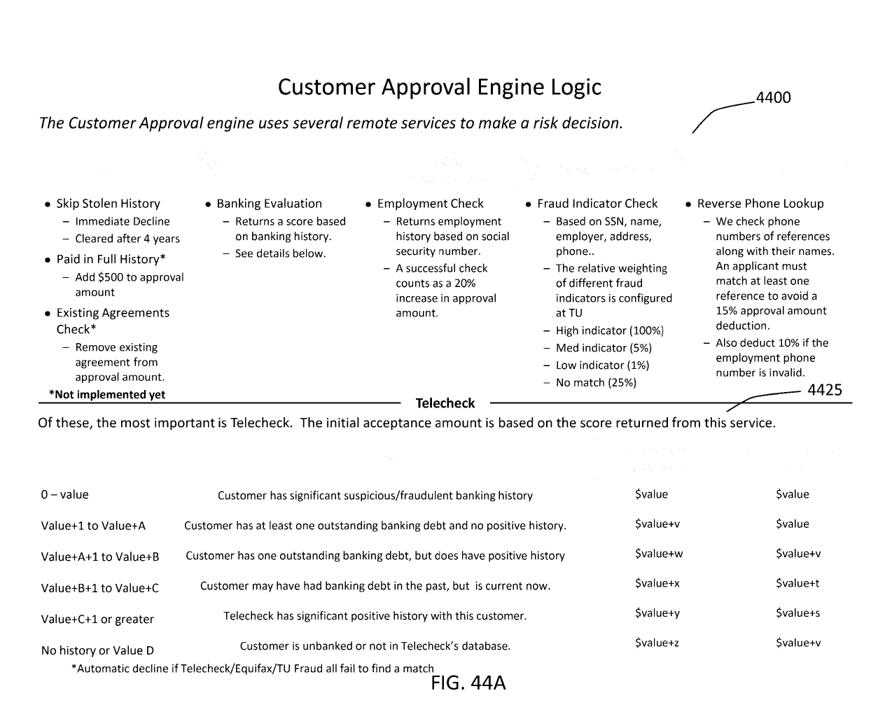

Referring to FIG. 43, in some embodiments, the lease-purchase system and method can include a “partner invoicing” phase 4325, “delivery confirmation” phase 4350, and an “account management” phase 4375. In some embodiments, during the “partner invoicing” 4325 phase, a vendor can enter an invoice in “RACA IM” (e.g., through the “Backend system” 3685). The vendor can invoice for each lease-purchase rental, pay the merchant for the agreement amount (e.g., via a ACH (Automated Clearing House) account), or offer the merchant a temporary “VCA” (Virtual Charge Account) number for each agreement. In some embodiments, the lease-purchase system and method can prompt for a delivery confirmation. For example, in some embodiments, during the “delivery confirmation” phase 4350, the lease-purchase system and method can send an automated communication to a customer to confirm delivery. In some embodiments, the communication can comprise an email. In some embodiments, the email can comprise a confirmation link. The customer can then respond as prompted to confirm a delivery (e.g., by either responding to the email and/or by clicking on the confirmation link), leading to the delivery entering a delivery confirmation queue. In other embodiments, the automated confirmation can comprise a text message, and the customer can confirm delivery by responding to the text message. In some further embodiments, the retailer can provide a delivery confirmation. In some embodiments, the lease-purchase system and method can seek confirmation by the retailer if the customer fails to confirm delivery. The “ESB services” 3675 can set status delivery confirmed with data transfer to the “Backend system” 3685, and the customer account can be managed using a third party (if desired) through the “Backend system” 3685.

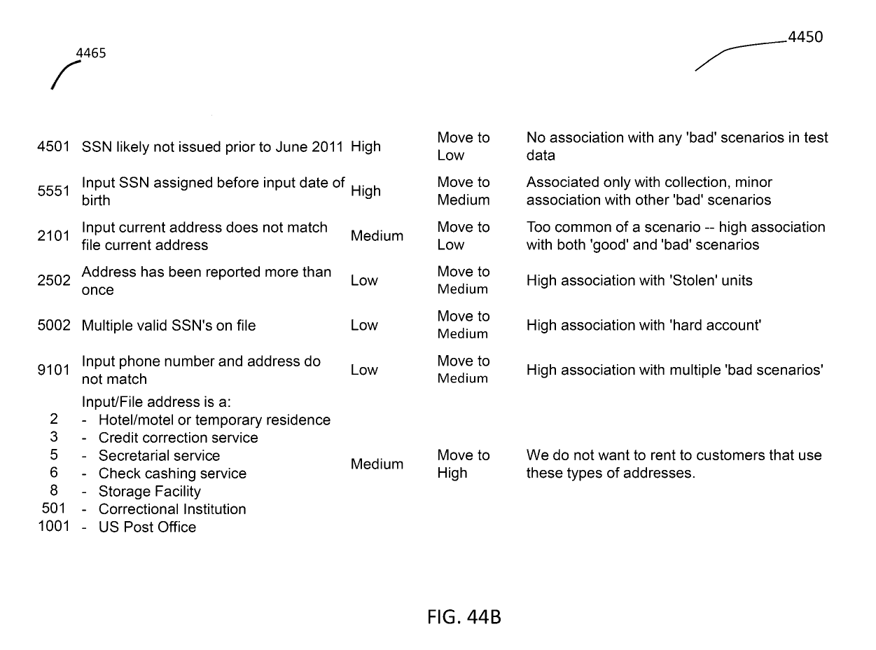

Further details of a customer approval process can be seen in FIG. 44A, illustrating an example of customer approval engine logic 4400 of the lease-purchase system and method in accordance with some embodiments of the invention. As shown, the lease-purchase system and method can use a plurality of services to make a risk decision. These can include the analysis of customer transaction data maintained and/or referenced by the point-of-sale system and use of third party services including, without limitation, Telecheck, Equifax, and TransUnion (“Fraud” and “Phone”). In some embodiments, customer transaction data or third party services can provide “Skip stolen history”, where the lease-purchase system and method can include an immediate decline and clear after four years of events. Further, in some embodiments, a “Paid in full history” can be provided, wherein the lease-purchase system and method can add a pre-determined amount (currently illustrated at $500) to the approval amount. Further, in some embodiments, an “Existing agreements check” can be provided, where the lease-purchase system and method can remove an existing agreement from the approval amount.

In some embodiments, the Telecheck third party service can provide a banking evaluation (shown as 4425). As shown, this service can provide a score based on the banking history but which is not based upon FICO scores or methodology. For example, in some embodiments, a score of “0-199” can indicate the customer has significant suspicious and/or fraudulent banking history. Further, a score of “200-399” can indicate the customer has at least one outstanding banking debt and no positive history. Further, a score of “400-599” indicates the customer has one outstanding banking debt, but does have positive history. Further, a score of “600-799” can indicate a customer may have had banking debt in the past, but is now current. Furthermore, a score of “800” or more can indicate that Telecheck has significant positive history with this customer. In some embodiments, a “Fraud Indicator Check” can include information comprising Social Security number, name, employer, address, phone. Further, the TransUnion third party service can return a fraud indicator to the lease-purchase system and method for use in the customer approval process. For example, the relative weighting of different fraud indicators is configured by TransUnion and can include “High indicator” (100%), “Med indicator” (5%), “Low indicator” (1%), and “No match” (25%).

FIG. 44B illustrates an example of logic used for a customer credit evaluation for the lease-purchase system and method in accordance with some embodiments of the invention. In some embodiments, a third party service such as TransUnion can assimilate fraud flags into a score that can be used by the lease-purchase system and method to evaluate a customer's approval amount. For example, referring to the risk column 4465, in some embodiments, a risk # of “4501” can be assigned to an instance where the Social Security number is not issued prior to June 2011. In some embodiments, a risk # of “5551” can indicate the received Social Security number was assigned before the input date of birth of the customer. In some further embodiments, a risk # of “2101” can indicate the input current address does not match the current address on file. Some embodiments include a risk # of “2502” can indicate the address has been reported more than once. In some embodiments, the risk # of “5002” can indicate the existence of multiple valid Social Security numbers. In some further embodiments, the risk # of “9101” can indicate the input phone number and address do not match. In some embodiments, other codes can be assigned to the input/file address such as “2” to indicate the address is a hotel, motel, or other temporary residence, “3”, that the address is a credit correction service, “5”, that the address is a secretarial service, “6”, that the address is a check cashing service, “8”, that the address is a storage facility, “501, that the address is a correctional institution, and “1001”, that the address is a United States Post Office.

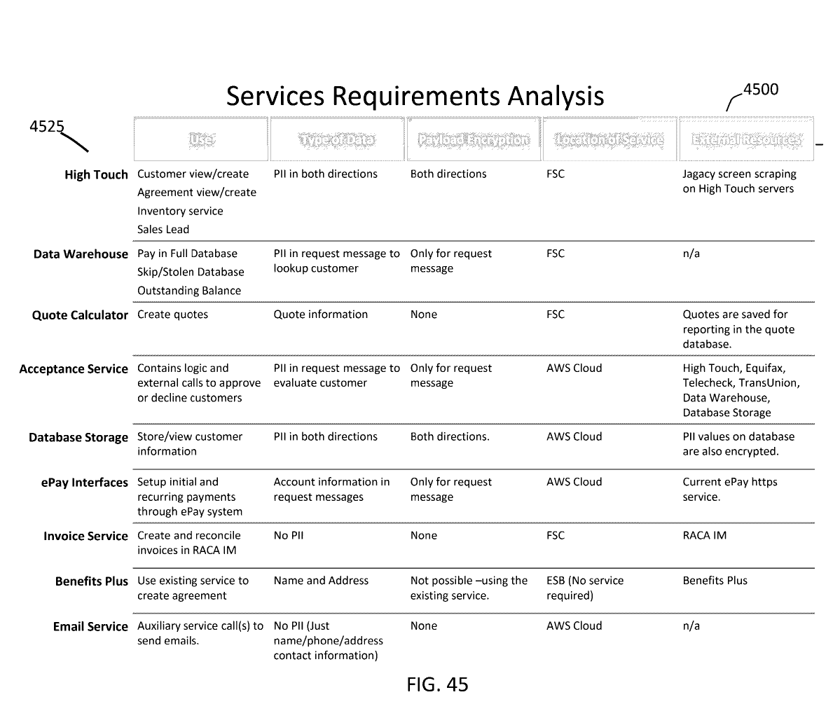

Third party services coupled to the lease-purchase system and method can include various services requirements. For example, FIG. 45 illustrates a services requirements analysis 4500 of the lease-purchase system and method in accordance with some embodiments of the invention. The third party services (shown as 4525) can include “Data Warehouse” services, “Quote Calculator” services, “Acceptance” services, “Database storage”, “ePay interfaces”, “Invoice service”, “Benefits Plus”, and/or “Email Service”. The tabulated information shown in the services requirements analysis 4500 of FIG. 45 includes the service use or definition, the type of data and data communication with the lease-purchase system and method, the payload encryption, the location of the service, and a description of external resources used by the service. More specifically, in addition to providing viewing and creation of customer account, and viewing and creation of customer agreements, the point-of-sale system and associated databases can include an inventory service, and can function as a service for sales leads. The type of data can comprise personally identifiable information (hereinafter “PII”) in both directions, with a field support center (“FSC”) location, and a payload encryption in both directions.

In some embodiments, the “Data Warehouse” can comprise various databases including a “Paid In Full” database, a “Skip/Stolen” database, and can house a customer's agreement payment history, outstanding balance information. Portions of this type of data can comprise a “PII” in request message to a lookup customer, a “FSC” location, and a payload encryption only for a request message.

In some embodiments, the “Quote Calculator”, functioning as a quote calculator can include quote information with no specific payload encryption. The service can be “FSC” located, and quotes can be saved for reporting in the quote database. Further, “Acceptance” services, comprising services that contain logic and external calls to approve or decline customers, can comprise “PII” in request to evaluate a customer. The payload encryption can be for the request message, and the service can be located in at least one cloud database (such as an Amazon Web Services (“AWS”)). Amazon is a registered trademark of Amazon.com, Inc., Seattle Wash. Further, “Database storage”, used for storing and viewing customer information can comprise “PII” and payload encryption in both directions. The service can be located in “AWS cloud”, and external resources can comprise of point-of-sale systems, Equifax, Telecheck, TransUnion, “Data Warehouse”, and “Database Storage”.

In some embodiments, the “ePay interfaces” can be used for setup of initial and recurring payments through the online payment solution (e.g., ePay system). Customer account information can be included in request messages, and payload encryption can be included for request messages. The service can be located in “AWS cloud”, and external resources can comprise current ePay https services. The “Invoice service” can create and reconcile invoice in “RACA IM”. This service can include no “PII” with no payload encryption. The type of data can include no “PII”, with no payload encryption. The service can be “FSC”, and external resources can comprise “RACA IM”. Further, “Benefits Plus” services can be used to create customer agreements for ancillary benefits and services using existing service agreements with the type of data comprising a customer's name and address. The location of the service can be “ESB”, and external resources can comprise “Benefits Plus”. Further, the “Email Service” can be used as auxiliary service calls to send emails. The type of data includes no “PII”, and can include customer name, address, phone number, and other contact information as required. In some embodiments, locations can be mapped using a third-party mapping service (e.g., through a Google Maps™ with an application programming interface). Google Maps™ is a trademark of Google Inc. in the United States and other countries.

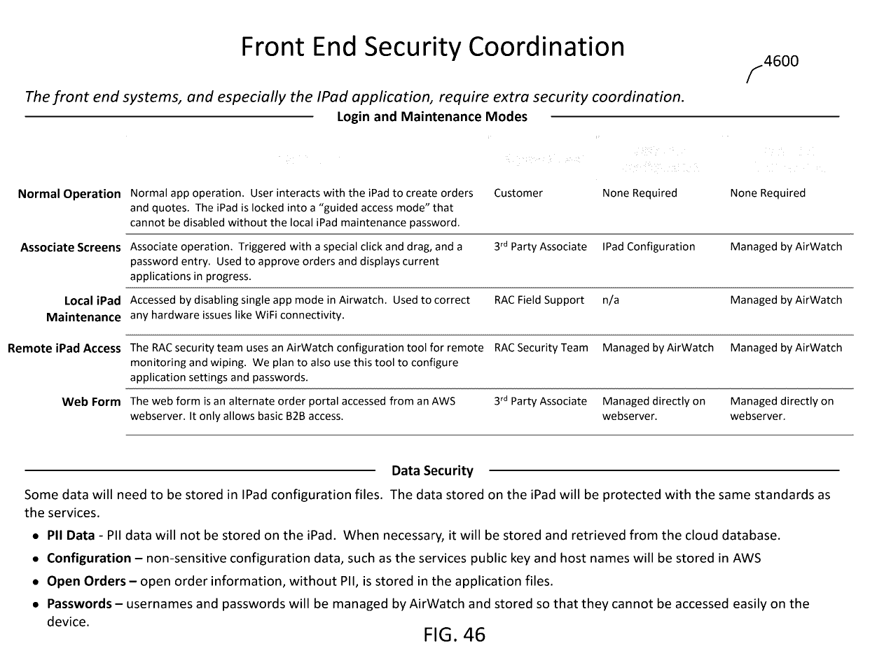

Some embodiments of the invention include a lease-purchase system and method that comprises various levels of security. For example, FIG. 46 illustrates a front-end security coordination 4600 of the lease-purchase system and method in accordance with some embodiments of the invention. In some embodiments, any of the front end systems, especially a kiosk (e.g., comprising an Apple iPad® or other computer tablet system) can require additional security coordination. iPad® is a registered trademark of Apple Inc.

As shown in the table of FIG. 46, in some embodiments, while operating in login and maintenance modes, the front end can require different security protocols. For example, during normal operation, the user can interact with the iPad to create orders and quotes. The iPad® is locked into a “guided access mode” that cannot be disabled without the local iPad® maintenance password. In this instance, the expected user is the customer, and no password configuration or maintenance is required. In some embodiments, during operation within an associate mode, associate operation can be triggered with a special click and drag, and a password entry. This can be used to approve orders and display current applications in progress. In this configuration, the expected user is a 3rd party associate. In some embodiments, the password configuration can use an iPad® configuration, and the password maintenance can be managed by a remote security and application management solution (e.g., AirWatch).

Some embodiments can include a maintenance mode. For example, local iPad® maintenance can include access by disabling the single application mode in AirWatch, and can be used to correct any hardware issues including WiFi connectivity. In this configuration, the expected user is a lease-purchase system and method field technician. The password configuration is not applicable, and password maintenance can be managed by AirWatch. Some embodiments of the invention can include remote access to a front end component. For example, some embodiments can include a remote iPad® access where a lease-purchase system and method security team can use an AirWatch configuration tool for remote monitoring and wiping. The tool can also be used to configure application settings and passwords. In some embodiments, a web form can be used as an alternate order portal accessed from an Amazon Web Services webserver. In this configuration, the expected user can be a third party associate, and the password configuration and maintenance can be managed directly by a webserver.

Some embodiments include various data storage preference for security. In some embodiments, some data can be stored in iPad® configuration files. The data stored on the iPad® can be protected with the same standards as the services. PII data will not be stored on the iPad® and, when necessary, can be stored and retrieved from the cloud database. In some embodiments, non-sensitive configuration data, such as the services public key and host names can be stored in AWS. Open order information, without PII, can be stored in the application files. Further, in some embodiments, passwords and usernames can be managed by a remote security and application management solution (e.g., AirWatch) and stored so that they cannot be accessed easily on the device.

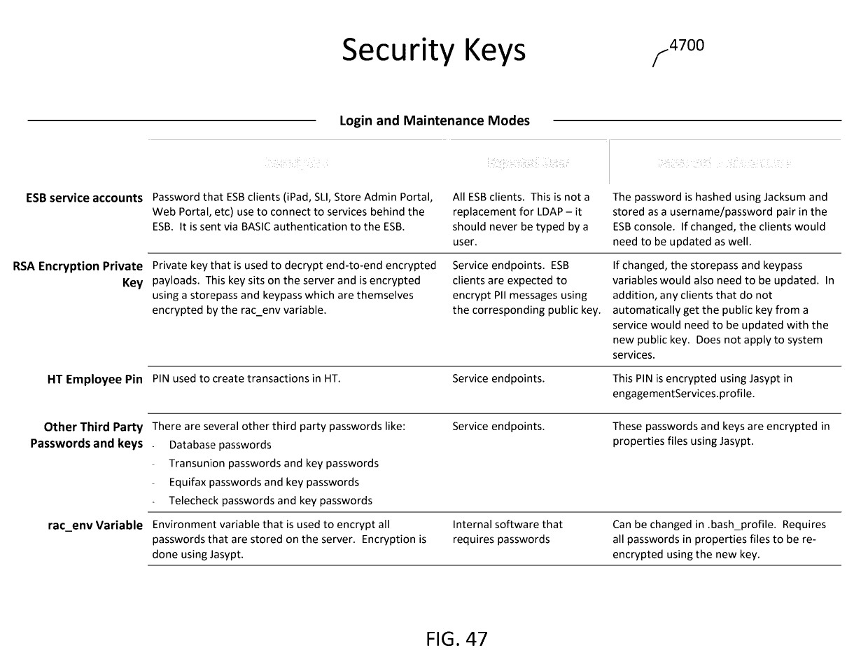

The lease-purchase system and method can include utilize various security keys to control and access information, and can be applied across login and maintenance modes. For example, FIG. 47 illustrates a security keys display 4700 of the lease-purchase system and method in accordance with some embodiments of the invention. As an example, for “ESB” service accounts, a security key can comprise one or more passwords that “ESB” clients (iPad, sales lead interface (“SLI”), “store admin portal”, “web portal”, etc.) can use to connect to service behind the “ESB”. In some embodiments, the password can be sent via basic access authentification to the “ESB”. The expected users of “ESB” service accounts can include all “ESB” clients, is not configured as a replacement for LDAP, and should not be typed by a user. In some embodiments, the password maintenance can comprise jacksum hashing, and can be stored as a username and password pair in the “ESB” console, and lease-purchase system and method clients can be informed if changed.

Some embodiments include an RSA encryption private key. For example, some embodiments can utilize a private key that is used to decrypt end-to-end encrypted payloads. In some embodiments, the key can reside on the server and can be encrypted using a storepass and keypass which are themselves encrypted by an environment variable “rac_env variable”. The expected user can include service endpoints. In some embodiments, “ESB” clients are expected to encrypt “PII” messages using the corresponding public key. If changed, the storepass and keypass variables can be updated. Further, any clients that do not automatically receive the public key from a service can be updated with a new public key.

Some embodiments can include an “HT employee PIN”. For example, some embodiments can use a security key that comprises a personal identification number (“PIN”) that can be used to create transactions in a point-of-sale system. The expected user can comprise service endpoints, and password maintenance can comprise encryption using “Jasypt” in engagementServices.profile.

Some embodiments can use other third party passwords and keys. For example, some embodiments can use other third party passwords including database passwords, TransUnion passwords and key passwords, Equifax passwords and key passwords, and Telecheck passwords and key passwords. The expected user can comprise service endpoints, and the passwords and keys can be encrypted in properties files using Jasypt.

In some embodiments, the “rac_env variable” can comprise an environment variable that is used to encrypt all passwords that are stored on the server, and encryption can be done using Jasypt. The expected user can include internal software that requires passwords. Further, passwords maintenance can includes changes in “.bash_profile”, and can require all passwords in property files to be re-encrypted using the new key.

It will be appreciated by those skilled in the art that while the invention has been described above in connection with particular embodiments and examples, the invention is not necessarily so limited by the description herein.

1. A system for generating a lease-purchase agreement comprising:
a non-transitory computer-readable medium in data communication with at least one processor, the non-transitory computer-readable medium including software instructions comprising a lease-purchase system and method; and
one or more processors configured to execute the software instructions to:
couple to at least one front end client comprising a customer interface including an approval session and an order session, the approval session configured to enable the customer to switch to the order session in the customer interface once approved;
process a customer application by initiating a customer approval engine in the approval session;
receive customer information from a customer;
couple to at least one verification server;
instruct the at least one verification server to execute at least one verification based at least in part on the customer information; and
wherein the at least one verification server transmits to the approval engine at least one notification based on the at least one verification;
determine an approval based at least in part on the at least one notification;
based on the approval, optionally entering an order session and initiating an ordering engine to create a customer order;
display at least one order selection page in the customer interface and configuring the customer display to receive order selection instructions from the customer for at least one good;
couple to at least one quote server;
instruct the at least one quote server to execute at least one quotation estimate based at least in part on the customer order; and
wherein the at least one quote server transmits to the ordering engine at least one quotation estimate;
generate at least one lease agreement related to the at least one good by coupling to at least one agreement server which stores information related to the at least one lease agreement in a non-transitory computer-readable medium; and
receive and display at least one lease agreement in the customer interface and configure the customer display to receive a customer signature or legally binding approval from the customer.

2. The system of claim 1, wherein the one or more processors are further configured to:
enter a sales associate mode including generating and displaying at least one customer progress dashboard.

3. The system of claim 2, wherein the one or more processors are further configured to:
display a customer order; and
wherein a viewing user can enter a confirmation of the customer order to initiate the order from the at least one customer progress dashboard.

4. The system of claim 2, wherein the one or more processors are further configured to:
enable a viewing user to review and execute an invoice and delivery related to the at least one good.

5. The system of claim 1, wherein the one or more processors are further configured to:
enable the front end client to accept an initial payment for the at least one good.

6. The system of claim 5, wherein the initial payment comprises a credit/debit card account from the customer.

7. The system of claim 5, wherein the initial payment comprises an online payment solution including an electronic funds transfer (“EFT”) or automated clearing house (“ACH”) payment.

8. The system of claim 7, wherein the online payment solution comprises at least one of ePay, Autopay, PayPal, Apple Pay, Google Wallet, Amazon Payments, and Skrill payments.

9. The system of claim 1, wherein the order session comprises displaying at least one order selection page, the order selection page configured to enable the customer to select the at least one good by department or category.

10. The system of claim 9, wherein the order selection page comprises at least one good customization tool which can access information related to the at least one good and stored in a non-transitory computer-readable medium.

11. The system of claim 9, wherein the one or more processors are further configured to define a price restriction on the at least one order, the price restriction including a specified minimum and maximum value.

12. The system of claim 1, wherein the one or more processors are further configured to display an estimate review display in the order session.

13. The system of claim 12, wherein the estimate review display comprises a display of an initial payment, and a monthly payment at least partially based on the specified time period, and the time period.

14. The system of claim 13, wherein the estimate review display comprises an early purchase option display comprising a user-definable early purchase option payment amount.

15. The system of claim 1, wherein the at least one front end client comprises a web coupled device and the approval and the approval session and order sessions transmit to the customer over the Internet.

16. The system of claim 1, wherein the at least one front end client comprises a kiosk device and the approval session and order session are displayed by the kiosk device.

17. A computer-implemented method of generating and executing lease-purchases comprising:
providing a system for generating a lease-purchase agreement comprising a non-transitory computer-readable medium in data communication with at least one processor, the non-transitory computer-readable medium including software instructions comprising a lease-purchase system and method which when executed by the at least one processor perform the process steps of;
coupling to at least one front end client comprising a customer interface, the customer interface comprising an approval session and order session, the approval session configured to enable the customer to switch to the order session in the customer interface once approved; and
processing a customer application by launching a customer approval engine in the approval session;
receiving customer information from a customer;
coupling to at least one verification server;
instructing the at least one verification server to execute at least one verification of the customer based at least in part on the customer information; and
wherein the at least one verification server transmits at least one notification to the approval engine based on the at least one verification; and
determining an approval based at least in part on the at least one notification;
based on the approval, optionally entering an order session and initiating an ordering engine to create a customer order;
displaying at least one order selection page in the customer interface;
receiving order selection instructions from the customer for at least one good;
coupling to at least one quote server;
instructing the at least one quote server to execute at least one quotation estimate based at least in part on the customer order; and
wherein the at least one quote server transmits to the ordering engine at least one quotation estimate; and
generating at least one lease agreement related to the at least one good by coupling to at least one agreement server; and
displaying at least one lease agreement in the customer interface; and
receiving a customer signature or legally binding approval from the customer in the customer interface.

18. The method of claim 17, further comprising software instructions which when executed by the at least one processor perform the process steps of;
entering a sales associate mode including generating and displaying at least one customer progress dashboard;
displaying at least one customer order; and
accepting input from a user to initiate the order from the at least one customer progress dashboard.

19. The method of claim 17, further comprising software instructions which when executed by the at least one processor perform the process steps of;
displaying an estimate review display in the order session, the estimate review display comprising a display of an initial payment, and a monthly payment at least partially based on the specified time period, and the time period, and an early purchase option display comprising a user-definable early purchase option payment amount if applicable; and
enabling the front end client to accept an initial payment for the at least one good, the initial payment comprising a customer's credit/debit card account or online payment solution account including an electronic funds transfer (“EFT”) or automated clearing house (“ACH”) payment.

20. The method of claim 17, wherein the at least one front end client comprises a web coupled device and the approval session and order session transmit to the customer over the Internet.

21. The method of claim 17, wherein the at least one front end client comprises a kiosk device and the approval session and order session are displayed by the kiosk device.

22. The method of claim 19, wherein the online payment solution account comprises at least one of ePay, Autopay, PayPal, Apple Pay, Google Wallet, Amazon Payments, and Skrill payments.
